(19) United States
(12) Patent Application Publication
(10) Pub. No.: US 2026/0340413 A1
(43) Pub. Date: Oct. 29, 2026

(54) SYSTEM AND METHOD FOR THREE-DIMENSIONAL (3D) INSTANCE SEGMENTATION

(71) Applicant: MOHAMED BIN ZAYED UNIVERSITY OF ARTIFICIAL INTELLIGENCE, Abu Dhabi (AE)

(72) Inventors: Mohamed El Amine BOUDJOGHRA, Abu Dhabi (AE); Jean LAHOUD, Abu Dhabi (AE); Hisham CHOLAKKAL, Abu Dhabi (AE); Rao Muhammad ANWER, Abu Dhabi (AE); Salman KHAN, Abu Dhabi (AE); Fahad Shahbaz KHAN, Abu Dhabi (AE)

(73) Assignee: MOHAMED BIN ZAYED UNIVERSITY OF ARTIFICIAL INTELLIGENCE, Abu Dhabi (AE)

(21) Appl. No.: 19/192,544

(22) Filed: Apr. 29, 2025

(51) Int. Cl. G06N 3/096; G06N 3/0455; G06V 10/77; G06V 10/774; G06V 10/82

(52) U.S. Cl. CPC G06N 3/096; G06N 3/0455; G06V 10/7715; G06V 10/774; G06V 10/82

(57) ABSTRACT

An open-world three-dimensional (3D) instance segmentation system and method for generating masks and class labels for instances in a 3D scene includes a sparse 3D convolutional network encoder to receive a voxelized 3D point cloud of the 3D scene and extract voxel features. The system includes a transformer decoder to predict an object binary mask and a class label for each of known and unknown 3D object instances, based on a set of initial queries and the extracted voxel features, and trained over tasks using class-incremental learning. The system includes a self-distillation module that during an i-th task, distills predictions from a pretrained teacher model into a student model being trained in the i-th task by generating a set of corrected pseudo labels used in training of the student model. Further, no exemplar replay is used during the training of the student model.

### STATEMENT REGARDING PRIOR DISCLOSURE BY THE INVENTORS

Aspects of this technology are described in a thesis authored by Mohamed Boudjoghra, titled “Open-World 3D Instance Segmentation,” published on Apr. 30, 2024, by Mohamed bin Zayed University of Artificial Intelligence (MBZUAI) and an article authored by Mohamed El Amine Boudjoghra, Jean Lahoud, Hisham Cholakkal, Rao Muhammad Anwer, Salman Khan, and Fahad Khan, titled “Continual Learning and Unknown Object Discovery in 3D Scenes via Self-Distillation,” and its Supplementary Material, both published at the 18th European Conference on Computer Vision (ECCV 2024), all incorporated herein by reference in their entireties.

### BACKGROUND

### Technical Field

The present disclosure is directed to artificial intelligence, computer vision, and 3D scene understanding, and more particularly, to systems and methods for open-world three-dimensional (3D) instance segmentation for generating masks and class labels for instances in a 3D scene.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Three-dimensional (3D) instance segmentation is a fundamental task in a computer vision that involves identifying and segmenting individual object instances within a 3D scene. Unlike semantic segmentation, which classifies each point in a scene without distinguishing between the object instances, instance segmentation predicts separate masks for each object, enabling more detailed scene understanding. Traditional 3D segmentation methods operate under a closed-world assumption, where models are trained on a fixed set of object categories and cannot recognize new, unseen classes. While effective in controlled environments, these methods are limited in real-world scenarios where new objects frequently appear.

Several instance segmentation techniques have been introduced within a closed-world setting, including top-down, bottom-up, and hybrid approaches. The top-down approach generates instance proposals from a primary stream and refines them with local features to predict final masks. While effective in capturing the object instances, the top-down approach often struggles with object boundaries and may suffer from proposal duplication. In contrast, the bottom-up approach performs the semantic segmentation first and then predicts the object instances within a same pipeline. Although this approach ensures better spatial consistency, it often leads to over-segmentation and misclassification due to its reliance on semantic labels. The hybrid approach, such as SoftGroup, integrates both approaches (i.e., the top-down approach and the bottom-up approach) to enhance segmentation quality by using proposal generation along semantic cues. Further, a state-of-the-art hybrid model, such as Mask3D, employs a convolutional neural network (CNN)-transformer architecture to generate class-mask predictions for all objects in the scene. However, despite their effectiveness, this model often fails to distinguish between background and known classes, leading to high false positive rates in cluttered environments.

To address the aforementioned issues, an open-world 3D instance segmentation has been introduced, allowing models to detect known and unknown objects while learning new classes incrementally. In one conventional approach, exemplar-based continual learning methods (e.g., 3D-open world instance segmentation (OWIS)) have been introduced that retain knowledge of previously seen classes by storing a subset of past labeled data (exemplars). However, stored exemplars only represent a fraction of past data, leading to incomplete retention of older knowledge. Additionally, memory constraints make storing the exemplars for large-scale applications impractical. In another conventional approach, open-world object detection methods without continual learning (e.g., open world detection transformer (OW-DETR), an open-world object detector via relational knowledge distillation (ORE), probabilistic objectness for open-world object detection (PROB), self-supervised open world transformer (SS-OWFormer)) have been introduced to focus on detecting the unknown objects but lack a mechanism to learn new object categories incrementally. As a result, they fail to retain knowledge of previous classes, causing catastrophic forgetting (i.e., where learning new object classes causes degradation in recognizing previously learned ones) when trained on new labels. Furthermore, these methods fail to balance identifying the unknown objects while maintaining performance on known categories. In yet another conventional approach, pseudo-label-based learning approaches have been introduced to recognize the unknown objects in an absence of annotated data by leveraging pseudo-labels. However, these pseudo-labels are often noisy and unreliable, leading to misclassification errors. The discrepancy between high-quality known labels and low-quality unknown labels further degrades model performance.

Thus, there is a need for more efficient approaches that address the aforementioned issues while improving segmentation performance for both known and unknown instances.

### SUMMARY

In an exemplary embodiment, an open-world three-dimensional (3D) instance segmentation system for generating masks and class labels for instances in a 3D scene is disclosed. The system includes a sparse 3D convolutional network encoder. The system further includes a transformer decoder. The system further includes a self-distillation module. The sparse 3D convolutional network encoder is configured to receive a voxelized 3D point cloud of the 3D scene and extract voxel features therefrom. The transformer decoder is configured to predict an object binary mask and a class label for each of a plurality of known and unknown 3D object instances in the 3D scene, based on a set of initial queries and the extracted voxel features. The transformer decoder is trained over a plurality of tasks using class-incremental learning. During an i-th task of the plurality of tasks, the self-distillation module distills predictions from a pretrained teacher model into a student model being trained in the i-th task by generating a set of corrected pseudo labels used in training of the student model, where i is an integer greater than or equal to 1. Further, no exemplar replay is used during the training of the student model.

In another exemplary embodiment, an open-world three-dimensional (3D) instance segmentation method for generating masks and class labels for instances in a 3D scene is disclosed. The method includes via a sparse 3D convolutional network encoder, receiving a voxelized 3D point cloud of the 3D scene and extracting voxel features therefrom. The method further includes via a transformer decoder, predicting an object binary mask and a class label for each of a plurality of known and unknown 3D object instances in the 3D scene, based on a set of initial queries and the extracted voxel features. The transformer decoder is trained over a plurality of tasks using class-incremental learning. The method further includes during an i-th task of the plurality of tasks, predictions from a pretrained teacher model are distilled by a self-distillation module into a student model being trained in the i-th task by generating a set of corrected pseudo labels used in training of the student model, where i is an integer greater than or equal to 1. No exemplar replay is used during the training of the student model.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A illustrates a conventional exemplar-based approach used in open-world three-dimensional (3D) instance segmentation.

FIG. 1B illustrates an exemplar-free self-distillation approach used in the open-world 3D instance segmentation, according to certain embodiments.

FIG. 2A illustrates an open-world 3D instance segmentation system for generating masks and class labels for instances in a 3D scene, according to certain embodiments.

FIG. 2B illustrates a self-distillation module (SDM) for the open-world 3D instance segmentation, according to certain embodiments.

FIG. 3 illustrates a transformer-based architecture, according to certain embodiments.

FIG. 4A illustrates a known-unknown self-distillation pipeline, according to certain embodiments.

FIG. 4B illustrates a visual representation of an unknown-known separation (UKS) component, according to certain embodiments.

FIG. 5A illustrates a a visualization of a first qualitative comparison of segmentation results of a conventional system, the system, and a ground truth, according to certain embodiments.

FIG. 5B illustrates a visualization of a second qualitative comparison between the conventional system, the system, and the ground truth, according to certain embodiments.

FIG. 6 illustrates a graphical representation of number of pseudo-labels generated for unknown classes over training epochs, according to certain embodiments.

FIG. 7 illustrates qualitative results of an input scene after progressively sampling different percentages (p %) of input points, according to certain embodiments.

FIGS. 8A-8H illustrate an exemplary qualitative comparison between a 3D-OWIS, an OpenDistill3D (self-distillation), and a ground truth across three sequential tasks, according to certain embodiments.

FIG. 9 illustrates a flowchart of an open-world 3D instance segmentation method for generating the masks and the class labels for instances in the 3D scene, according to certain embodiments.

FIG. 10 is an illustration of a non-limiting example of details of computing hardware used in a computing system, according to certain embodiments.

FIG. 11 is an exemplary schematic diagram of a data processing system used within the computing system, according to certain embodiments.

FIG. 12 is an exemplary schematic diagram of a processor used with the computing system, according to certain embodiments.

FIG. 13 is an illustration of a non-limiting example of distributed components which may share processing with a controller, according to certain embodiments.

### DETAILED DESCRIPTION

In the drawings, like reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a system and method for open-world three-dimensional (3D) instance segmentation, enabling continual learning and unknown object identification without reliance on exemplars. Conventional approaches in the open-world 3D instance segmentation have addressed the continual learning and the unknown object identification separately, leading to suboptimal performance in segmenting unknown instances and ineffective mitigation of catastrophic forgetting. The conventional approaches often require dedicated memory storage for historical data samples, increasing memory consumption and limiting scalability in real-world applications.

The present disclosure discloses an exemplar-free approach for 3D continual learning and unknown class discovery through self-distillation. This approach leverages pseudo-labels generated by a model from previous learning tasks to enhance unknown object predictions while preserving knowledge of previously learned classes. By integrating the pseudo-labels into a continual learning process, the present disclosure improves both recognition of new instances and a retention of prior knowledge. Unlike the conventional approaches that rely on explicit memory storage for historical data, the present disclosure efficiently utilizes prior model knowledge to achieve superior performance in continual learning and unknown class retrieval. In addition, the effectiveness of the exemplar-free approach is validated by performing comprehensive experiments on various splits of a ScanNet200 dataset, illustrating significant improvements over state-of-the-art methods.

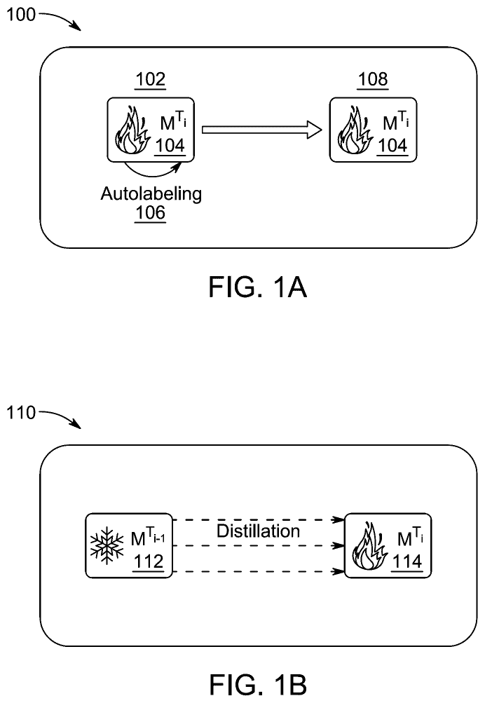

FIG. 1A illustrates a conventional exemplar-based approach 100 used in open-world 3D instance segmentation. The exemplar-based approach 100 is employed by methods such as, but not limited to, 3D-open world instance segmentation (OWIS), an open-world object detector via relational knowledge distillation (ORE), an open world detection transformer (OW-DETR), a probabilistic objectness for open-world object detection (PROB), a semi-supervised open world object detection transformer (SS-OWFormer), and so forth. The methods follow a two-phase learning process to incrementally learn new object classes (i.e., categories of objects) while preserving knowledge of previously known classes. In a first phase 102, a model M^{T}^{ᵢ} 104 is trained on known classes from a current task, including previously learned classes and new object categories that were not part of earlier tasks. During this phase, an auto-labelling mechanism 106 is used to detect and classify previously unknown objects (i.e., objects that the model has not encountered before). For example, if the model was previously trained only on furniture objects (e.g., chairs, tables) and is now being introduced to electronic devices (e.g., laptops, monitors), then the model must learn to classify new classes in a scene and prepare for further classification.

Following the first phase 102, a second phase 108 includes exemplar-based fine-tuning, where the model M^{T}^{ᵢ} 104 is refined using stored exemplars from the previously known classes to mitigate catastrophic forgetting (where the model loses previously learned knowledge when exposed to new tasks). For instance, if the model has learned about bottles and chairs in earlier tasks, it retains a few labelled examples of the objects and reuses examples in future training sessions to reinforce old knowledge. While the exemplar-based approach 100 helps retain past knowledge, it introduces several challenges. Firstly, the exemplar-based approach 100 demands a high memory requirement, as storing the exemplars significantly increases memory consumption over time. Secondly, the exemplar-based approach 100 remains susceptible to forgetting, as the exemplars provide only a limited representation of past data, leading to partial knowledge loss. Lastly, a two-phase complexity extends a training process, making it computationally intensive due to additional fine-tuning steps. These challenges represent inefficiencies of the exemplar-based approach 100 in continually learning and recognizing the unknown objects within an open-world setting.

FIG. 1B illustrates an exemplar-free self-distillation approach 110 used in the open-world 3D instance segmentation, according to certain embodiments. The exemplar-free self-distillation approach 110 is designed for the open-world 3D instance segmentation, to detect, segment, and learn the new object classes over time while retaining knowledge of the previously known classes and object instances. The exemplar-free self-distillation approach 110 removes the need for the exemplars by utilizing the knowledge from a previous model (M^{T}^{ᵢ}⁻¹, also known as a teacher model 112) and transferring the knowledge to a current model (M^{T}^{ᵢ}, or a student model 114). As used herein, the term “self-distillation” is a process where a neural network improves itself by training on its own previous predictions instead of relying on manually stored data. For example, suppose the model previously recognized the chair in the 3D scene. In that case, the model may use a prior understanding to identify similar structures in new data, even if explicit training examples of the chair are not stored.

Since the self-distillation is an exemplar-free approach 110, it does not require storing large amounts of past data, making it highly memory efficient. Unlike the exemplar-based approach 100 (discussed in FIG. 1A), where memory usage grows as more data is accumulated, the exemplar-free self-distillation approach 110 maintains a fixed memory footprint, making it scalable for real-world applications (i.e., autonomous robots and augmented reality systems). Further, the exemplar-free self-distillation approach 110 improves the recognition of known and unknown classes. Since the teacher model M^{T}^{ᵢ}⁻¹ 112 retains the knowledge from earlier tasks, the student model M^{T}^{ᵢ} 114, may preserve the past data while adapting to new categories, ensuring better segmentation of previously encountered objects.

For instance, in a self-driving car application, an artificial intelligence (AI) model trained on a dataset containing cars, pedestrians, and traffic signs should be able to recognize newly introduced vehicle types without forgetting its knowledge of older models. The exemplar-free self-distillation approach 110 ensures that as the AI model learns to detect new vehicles (e.g., electric scooters), the AI model retains its ability to recognize traditional cars and the traffic signs without requiring stored training samples. Hence, the exemplar-free self-distillation approach 110 eliminates a trade-off between memory efficiency and continual learning, making it an ideal approach for scalable, real-time, and resource-efficient 3D instance segmentation.

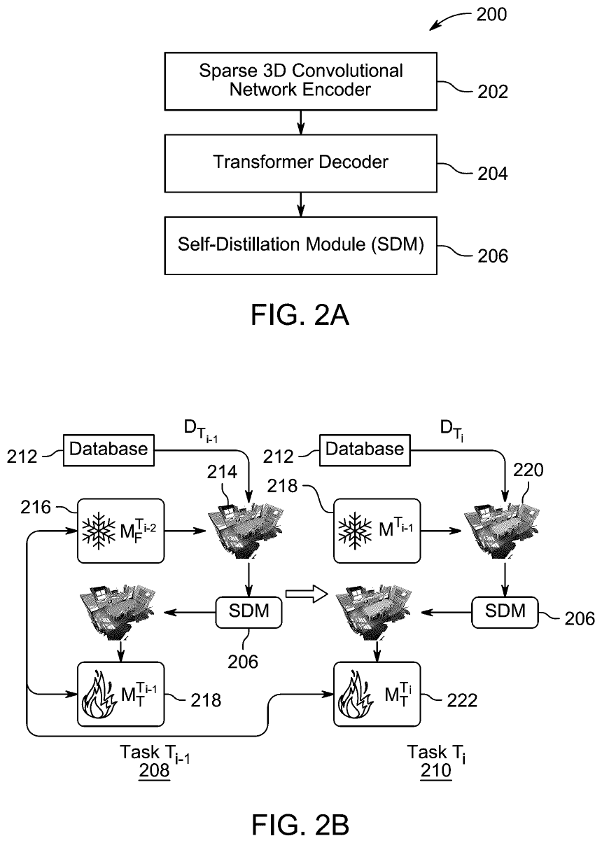

FIG. 2A illustrates an open-world 3D instance segmentation system 200 for generating masks and class labels for instances in the 3D scene, according to certain embodiments. The system 200 includes a sparse 3D convolutional network encoder 202 configured to receive a voxelized 3D point cloud of the 3D scene and extract voxel features therefrom. In an embodiment, the sparse 3D convolutional network encoder 202 may be configured to receive the voxelized 3D point cloud of the 3D scene from a preprocessing module (not shown) that may convert raw light detection and ranging (LiDAR) scans or depth sensor data (e.g., aerial LiDAR scans, autonomous vehicle LiDAR point clouds, robotic navigation depth data, mobile phone LiDAR captures, and so forth) into a structured voxel representation (i.e., a discretized 3D grid-based format in which a continuous point cloud is converted into regularly spaced volumetric units called voxels). The preprocessing module may include a voxelization step, where a continuous 3D point cloud captured by LiDAR or other depth sensors is discretized into a regular 3D grid (grid of voxels). Each voxel represents a small cubic region in a 3D space and stores information such as the presence of points, intensity values, or learned features of objects in a structured grid format. The voxelization step ensures that the system 200 efficiently processes the voxelized 3D point cloud using sparse 3D convolutions while preserving a spatial structure of the objects.

In an embodiment, the sparse 3D convolutional network encoder 202 utilizes frameworks, such as, but not limited to, SparseConvNet (SCN), Minkowski engine, sparse point-voxel neural architecture search (SPVNAS), and other sparse convolutional techniques for efficient 3D point cloud processing. The frameworks employ the sparse 3D convolutions to extract spatial and geometric features (e.g., edges, surfaces, object boundaries, shape contours, and spatial relationships between the objects) while preserving the structural integrity of large-scale point clouds. In a preferred embodiment, the sparse 3D convolutional network encoder 202 includes a 3D U-Net-based Convolutional Neural Network to process the received voxelized 3D point cloud, enabling hierarchical feature extraction and enhanced segmentation performance.

In an exemplary embodiment, the 3D U-Net-based Convolutional Neural Network may be configured to process the voxelized 3D point cloud by operating only on occupied voxels (i.e., voxels that contain one or more points from an original point cloud, representing surfaces or objects rather than an empty space), allowing for computational efficiency while preserving critical spatial details. In an embodiment, the 3D U-Net-based Convolutional Neural Network applies a series of 3D convolutional layers to learn hierarchical representations, capturing local and global spatial dependencies (e.g., local dependencies such as a curvature of an object's surface or an arrangement of small features like edges and corners, and global dependencies such as a relative positioning of objects within the scene or an overall spatial layout of a room). Lower layers extract fine-grained geometric details, such as edges and small surface variations, while deeper layers extract higher-level structural patterns, including object boundaries and spatial relationships. Through the hierarchical feature extraction, the voxel features are extracted at multiple scales, ensuring a rich representation of the 3D scene. The extracted voxel features encode essential geometric and semantic information, which aids in accurately segmenting the objects and distinguishing between different instances. As a result, the 3D U-Net-based Convolutional Neural Network effectively captures the spatial and geometric features within the scene, generating high-dimensional voxel-level feature embeddings (i.e., compact numerical representations of voxel properties, such as shape, texture, and spatial relationships, that encode meaningful geometric and semantic information for downstream tasks like segmentation, self-distillation, and open-world learning). For example, in the 3D scene of the room containing the table and the chair, the sparse 3D convolutional network encoder 202 identifies a flat surface of the table, distinct edges of the chair, and their spatial arrangement. By using the sparse 3D convolutions, the system 200 enables efficient processing of large-scale 3D scenes while maintaining fine details necessary for accurate instance segmentation and open-world adaptation.

The system 200 further includes a transformer decoder 204 configured to receive the extracted voxel features from the sparse 3D convolutional network encoder 202. The transformer decoder 204 is configured to predict an object binary mask and a class label for each of a plurality of known and unknown 3D object instances in the 3D scene, based on a set of initial queries and the extracted voxel features. As used herein, the term “object binary mask” refers to a 2D or 3D matrix where each element (pixel or voxel) is assigned a binary value (0 or 1) to indicate presence or absence of a specific object. In 3D instance segmentation, the object binary mask is applied in a voxel space, marking regions occupied by a detected object. Also, as used herein, the term “class label” refers to a categorical identifier that specifies a type or category of the object in the 3D scene. In semantic segmentation, each pixel in the image may be labeled with a class (e.g., “Tree,” “Building,” “Person”).

Further, the set of initial queries are trainable embeddings that are learned during training. In an embodiment, the set of initial queries may be fixed regardless of a number of objects in the 3D scene. The transformer decoder 204 is configured to refine the set of initial queries iteratively through a plurality of self-attention and cross-attention with the extracted voxel features to generate a set of refined queries. Each refined query is used to generate the object binary mask and the corresponding class label. The iterative refinement process ensures that the transformer decoder 204 effectively captures both local contextual information (e.g., fine-grained shape details, object boundaries, small structural features) and global contextual information (e.g., spatial relationships between the objects, scene layout, overall object distribution). In an exemplary embodiment, the transformer decoder 204 may be configured to utilize the set of initial queries that serve as object proposals (i.e., candidate representations of potential objects in the 3D scene, which are iteratively refined to determine their final segmentation masks and class labels; for example, an initial query may correspond to a rough estimate of a chair's location, which is later refined to segment the structure of the chair accurately). The set of initial queries is refined through multiple layers of the self-attention, where the queries interact with each other to improve object representation, and the cross-attention, where the queries interact with the voxel features to extract the spatial and geometric information.

In the self-attention, each query interacts with all other queries in the set of initial queries, allowing the transformer decoder 204 to capture relationships between different object proposals. This helps refine the object representation by considering contextual information from other potential objects in the scene. For example, if the initial query corresponds to the rough estimate of the chair's location, the self-attention allows it to refine its understanding by incorporating information from nearby object queries, such as the table or another chair.

In the cross-attention, the refined queries interact with the extracted voxel features to align with the spatial and geometric information from the 3D scene. Each query focuses on relevant voxel features, enabling the transformer decoder 204 to refine the object boundaries and improve classification. For instance, a query for the chair may focus on the voxel features corresponding to its legs, seat, and backrest, distinguishing the chair from surrounding objects.

Through an iterative refinement process of the queries, the transformer decoder 204 generates final refined queries, which enhance a prediction of the binary object mask and the class label and improve 3D instance segmentation accuracy in the 3D scene.

The final refined queries from the transformer decoder 204 are represented as:

Q={qᵢϵR^{d}|iϵ(1,2, . . . ,n_{Q})}, (1)

where d is the dimension of each query, n_{Q} is the total number of queries, Q is the set of final refined queries in the 3D instance segmentation in a closed-set model, qᵢ represents i^{th} query in set Q, R^{d} represents d-dimensional real-valued vector space, meaning that each query qᵢ is a d-dimensional feature vector. Once the set of initial queries is refined, the refined queries are used to generate the object binary masks and class label predictions.

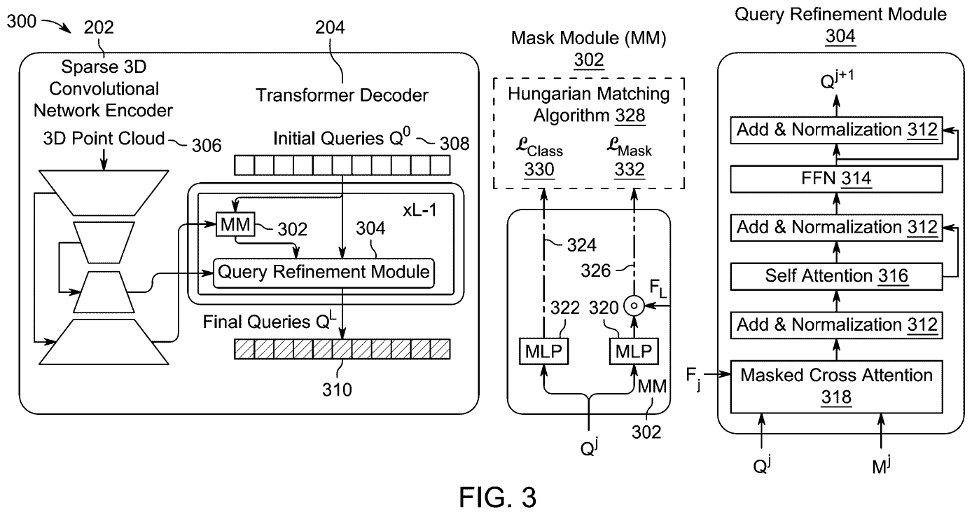

Further, the transformer decoder 204 is trained over a plurality of tasks using a class-incremental learning (CIL) to incorporate the new object classes over time while retaining the previously learned knowledge. As used herein, the term “CIL” refers to a learning paradigm where the model continuously learns the new object classes over multiple training sessions, rather than being trained on all classes at once. In an embodiment, the training follows the exemplar-free self-distillation approach 110 (as discussed above in FIG. 1B), where during an i-th task, a student model learns from a teacher model that was previously trained on an (i−1)-th task. This ensures that knowledge from earlier tasks is retained while adapting to the new classes. In the exemplar-free self-distillation approach 110, both the teacher model and the student model share an identical architecture, ensuring consistency in learning representations across incremental tasks. In an embodiment, the teacher model and the student model are Mask3D-based transformer models. In other words, the teacher model and the student model are built on top of Mask3D, which is a transformer-based architecture 300 (as explained in FIG. 3) designed for the 3D instance segmentation using the sparse 3D convolutional network encoder 202 and the transformer decoder 204. In an embodiment, upon completion of the (i−1)-th task of the plurality of tasks, the student model is frozen and used as the teacher model for the i-th task. In other words, upon completing the (i−1)-th task, the student model that has been trained on both previously known and newly introduced classes is frozen and repurposed as the teacher model for the subsequent i-th task. In a progressive self-distillation process, a new student model is initialized for task i and learns from both frozen teacher's predictions and new ground truth labels. By continuously transferring the knowledge in this manner, the model effectively retains prior learning while adapting to the new object categories, without using exemplar replay during the training of the student model. This enables efficient and scalable learning in the open-world 3D instance segmentation while mitigating the catastrophic forgetting. For the first task (i=1), the teacher model is initialized using a closed-set model pre-trained on the known classes, providing a strong foundation for subsequent open-world learning. In other words, before the teacher model begins learning in the open-world setting, the teacher model is first trained on a controlled dataset containing a predefined set of object classes. For example, in an indoor scene segmentation task, an initial teacher model may be trained on the objects such as chairs, tables, and sofas, ensuring it has a solid foundation in recognizing these common objects. When a first incremental learning task begins (i=1), the pre-trained model serves as the teacher model, guiding the student model to learn from its predictions and the newly introduced classes. This setup allows the model to transition smoothly from the closed-world to the open-world setting, ensuring that the model starts with a strong baseline and can progressively incorporate the new object categories while retaining the previously learned knowledge.

During the i-th task of the plurality of tasks, a self-distillation module (SDM) 206 distills the predictions from the pre-trained teacher model into the student model being trained in the i-th task by generating a set of corrected pseudo labels used in training of the student model. In an embodiment, i is an integer greater than or equal to 1. The SDM 206 corrects the predictions from the teacher model that belong to the unknown classes but were misclassified as the previously known classes. For example, in the 3D indoor scene segmentation task, suppose the teacher model, trained only on a limited set of objects such as chairs, tables, and shelves, encounters a cabinet in a new task. If the teacher misclassifies the cabinet as a “shelf” due to their visual similarity, the SDM 206 corrects the label to an “unknown” label, ensuring that the student model does not inherit this misclassification. In an instance, the corrected pseudo label is then fed into the training of the student model, ensuring that it gradually learns to differentiate between the known and unknown classes. This iterative refinement enables the model to improve its generalization ability while gradually incorporating the new object categories without forgetting the previously learned knowledge.

Further, the SDM 206 concatenates the corrected pseudo-labels with the ground-truth labels of the known classes in the i-th task, forming a set of target pseudo-labels that supervise the training of the student model. This combined set ensures that the student model receives supervision for the previously known classes (via ground-truth labels) and the unknown classes that are reclassified more accurately through the self-distillation process. To further enhance learning, the SDM 206 estimates an objectness score for each target pseudo-label. The objectness score is derived from an objectness function that maps a mask prediction and a class probability to an objectness score ranging from 0 to 1, improving the reliability of pseudo-label supervision.

FIG. 2B illustrates the SDM 206 for the open-world 3D instance segmentation, according to certain embodiments. The SDM 206 is depicted across two incremental tasks, such as Task Tᵢ₋₁ 208 and Task Tᵢ 210. The SDM 206 enables the model to incrementally learn the new object classes while preserving the knowledge of the previously known and unknown classes.

In Task Tᵢ₋₁ 208, a process of self-distillation begins with a database 212 (e.g., Oracle), which provides a labeled dataset D_{T}_{ᵢ₋₁}. In an exemplary embodiment, the dataset D_{T}_{ᵢ₋₁} may contain the labels that belong to a predefined set of known classes (e.g., “chair,” “table,” “sofa”) but does not include the labels for the unknown classes that may appear in a 3D point cloud scene 214.

The dataset D_{T}_{ᵢ₋₁} is applied to the 3D point cloud scene 214 that is a digital representation of real-world objects in the 3D space. The 3D point cloud scene 214 is then processed by a frozen teacher model

$${M}_{F}^{{T}_{i - 2}}$$

216, which has been trained on the previous tasks, to make the predictions for the known classes while failing to assign the labels to the unknown classes. The

$${M}_{F}^{{T}_{i - 2}}$$

216 is called frozen as it is not updated or retrained; instead, it acts as a stable reference to guide learning. The predictions from the frozen teacher model

$${M}_{F}^{{T}_{i - 2}}$$

216 are then passed to the SDM 206, which refines the predictions by generating the pseudo-labels for the unknown classes (i.e., classes that are not explicitly labeled in D_{T}_{ᵢ₋₁}). In an exemplary embodiment, the table, which was initially recognized as the known class, is reclassified as the unknown class after the refinement by the SDM 206. The pseudo-labels act as weak supervision, allowing the model to begin recognizing the classes that were not explicitly labeled in D_{T}_{ᵢ₋₁}. The student model

$${M}_{T}^{{T}_{i - 1}}$$

218 is trained using the ground truth labels for the known classes and pseudo-labeled unknown classes. Additionally, a raw point cloud scene is also provided as input to the student model

$${M}_{T}^{{T}_{i - 1}}$$

218, allowing it to refine the segmentation and classification of the classes.

As the learning process continues to Task Tᵢ 210, the database 212 provides a new dataset D_{T}_{ᵢ}, which includes the previously unknown classes that are now labeled. For example, if “lamp” was unknown in the Task Tᵢ₋₁ 208, it is now explicitly labeled as “lamp” in D_{T}_{ᵢ}. The dataset D_{T}_{ᵢ} is again applied to a new 3D point cloud scene 220, which contains a mix of the previously known classes (e.g., “chair”, “table”), newly labeled classes (e.g., “lamp”) and potential new unknown classes that have not been labeled yet. In an exemplary embodiment, the previously unknown table is now correctly labeled as the currently known class. Instead of discarding past knowledge, the frozen teacher model

$${M}_{F}^{{T}_{i - 2}}$$

216 from the previous Task Tᵢ₋₁ 208, is reused to generate the predictions for both previously known and unknown classes. This step ensures that the model retains its ability to recognize the previously known classes while adapting to new ones. These predictions are again refined by the SDM 206 and generate the pseudo labels, ensuring that the previously misclassified unknown classes are now correctly labeled in a newly introduced dataset while continuing to identify any newly emerging unknown classes. Also, a trainable student model

$${M}_{T}^{{T}_{i}}$$

222 is optimized using both the ground truth labels for the new classes and the improved pseudo-labels for the unknown classes.

The SDM 206 enables continuous learning without catastrophic forgetting. Over multiple tasks, the SDM 206 ensures that the model progressively improves its ability to recognize both previously known and newly discovered classes. The transition from the previously known classes to the pseudo-labeled classes and then to currently known classes effectively demonstrate the model's continuous learning capability. This self-distillation process enables efficient open-world 3D instance segmentation, making it highly applicable in real-world scenarios such as autonomous robots, self-driving vehicles, and AI-powered inventory management systems.

FIG. 3 illustrates the transformer-based architecture 300, according to certain embodiments. The transformer-based architecture 300 includes components such as the sparse 3D convolutional network encoder 202, the transformer decoder 204, a mask module (MM) 302 and a query refinement module 304. The components of the transformer-based architecture 300 work together to extract the voxel features, refine object representations, and generate accurate segmentation masks. In a first stage, the sparse 3D convolutional network encoder 202 is configured to extract the voxel features from a 3D point cloud 306. The sparse 3D convolutional network encoder 202 processes the 3D point cloud 306 hierarchically, capturing essential spatial and geometric details while reducing the dimensionality of input data (3D point cloud 306). In an embodiment, the extracted voxel features provide a structured representation that may be essential for accurate segmentation. The voxel features are represented at different stages of processing (Fⱼ as an intermediate voxel feature representation and F_{L} as a final voxel feature output). The extracted voxel features serve as inputs to the transformer decoder 204.

As shown in FIG. 3, an output from the sparse 3D convolutional network encoder 202 is directed to both the MM 302 and the query refinement module 304 in the transformer decoder 204. This indicates that the extracted voxel features, denoted as Fⱼ (intermediate voxel features) and F_{L} (final voxel features), serve multiple roles in the instance segmentation process. In an embodiment, the final voxel features F_{L} are provided to the MM 302, and the intermediate voxel features Fⱼ are fed into the query refinement module 304.

In a second stage, the transformer decoder 204 takes a set of initial trainable queries (Q⁰) 308, which act as object proposals representing potential instances in the 3D scene. The transformer decoder 204 iteratively refines the set of initial trainable queries (Q⁰) 308 through multiple layers (over L levels) of self-attention 316 and masked cross-attention 318 with the voxel features. After undergoing L iterations of the refinement, a final set of refined queries (Q^{L}) 310 is obtained, significantly enhancing the quality of the object representations before segmentation.

In an embodiment, during each iteration j, the queries Q^{j} undergo transformations through the query refinement module 304, which includes several operations, such as add & normalization 312, feed-forward networks (FFN) 314, the self-attention 316, and the masked cross-attention 318. These operations progressively enhance the queries Q^{j}, allowing them to encode rich spatial and geometric context extracted from the voxelized 3D point cloud 306. At a j-th iteration, the refined query set Q^{j} is passed to the MM 302 for mask generation and classification.

Within the query refinement module 304, the refinement process begins with the operation of “add & normalization” 312, which normalizes the queries Q^{j}, ensuring stable learning and preventing gradient explosion. After normalization, the queries Q^{j} are processed through the FFN 314, which applies non-linearity and expands their representation capacity, allowing the model to learn richer feature embeddings. Further, an output of the FNN 314 is added back to Q^{j} through a residual connection, followed by another operation of “add & normalization” 312 to stabilize the transformation. As used herein, the term “residual connection” refers to a skip connection, which is a technique used in deep learning models where an input to a layer (or block of layers) is added to its output.

Further, the self-attention 316 refines the queries Q^{j} by allowing them to interact with one another in a shared feature space. This helps the model capture inter-object relationships, enabling the queries Q^{j} to refine themselves based on dependencies between different objects in the scene. The output of the self-attention 316 is then added back to the queries Q^{j} via the residual connection, followed by another operation of “add & normalization” 312.

After the self-attention 316, the queries Q^{j} undergo the masked cross-attention 318, where the queries Q^{j} interact with both the voxel features Fⱼ and intermediate mask representations MJ. The masked cross-attention 318 allows each query to attend selectively to relevant voxel features, integrating the spatial and geometric information while filtering out irrelevant data. The output of the masked cross-attention 318 is added back via the residual connection, followed by another “operation of add & normalization” 312.

The final output of the query refinement module 304 is an updated query set, denoted as Q^{j+1} which is passed to a next iteration for further refinement. The structured flow of the self-attention 316, the cross-attention 318, the residual connections, and the normalization ensures that each iteration contributes to better object understanding, ultimately leading to high-quality segmentation masks and class predictions.

In the MM 302, the refined query set Q^{j} is used in conjunction with the final voxel features F_{L} to generate binary object masks 326 and class predictions 324. The MM 302 applies Multi-Layer Perceptrons (MLPs) 320, 322 to process the refined query set Q^{j} and the final voxel features F_{L}, ensuring that each prediction is aligned with a representation of the input point cloud 306. In addition, a Hungarian matching algorithm 328 is performed to associate the predicted binary object masks 326 with the ground truth labels, using classification loss L_{class} 330 and Lₘₐₛₖ 332 for optimization.

In an exemplary embodiment, each query q is processed through two separate MLPs 320, 322, one for mask prediction 326 and another for class prediction 324. For the mask prediction 326, the query q is mapped to a feature space using a first MLP (i.e., MLPₘₐₛₖ) 320, and then a dot product is computed with the final voxel features F_{L}, which produces a mask prediction function as:

fₘₐₛₖ(q)=Sigmoid(MLPₘₐₛₖ(q)·F_{L}), (2)

where fₘₐₛₖ indicates the mask prediction function that maps q into the mask prediction, F_{L}ϵR^{d*N} represents the voxel features extracted from a high-resolution layer of CNN backbone, N is the total number of input voxels, a sigmoid activation function ensures that output values lie between 0 and 1, forming a probability map that indicates a likelihood of each voxel belonging to the predicted object instance and MLPₘₐₛₖ 320 is (R^{d}→R^{d}^{_{F}}) that represents a multi-layer perceptron that maps the query to the dimension of the feature map.

For the class prediction, the query is processed through another MLP, MLP_{class} 322 that maps the query's dimension to the total number of classes (including a background class). The final class prediction function is represented as:

f_{class}(q)=Softmax(MLP_{class}(q)) (3)

where f_{class} represents the class prediction function that maps q into the class prediction, a softmax activation function normalizes class scores into probabilities, allowing the transformer decoder 204 to determine the most likely class for each object instance. MLP_{class} 322 is (R^{d}→R^{C+1}) that represents a multi-layer perceptron that maps from the query's dimension to the total number of classes.

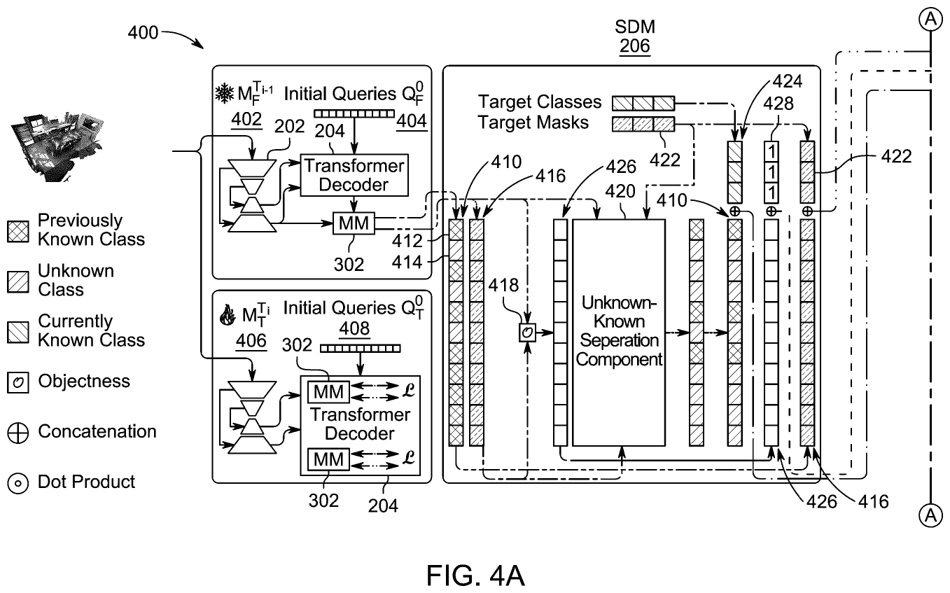

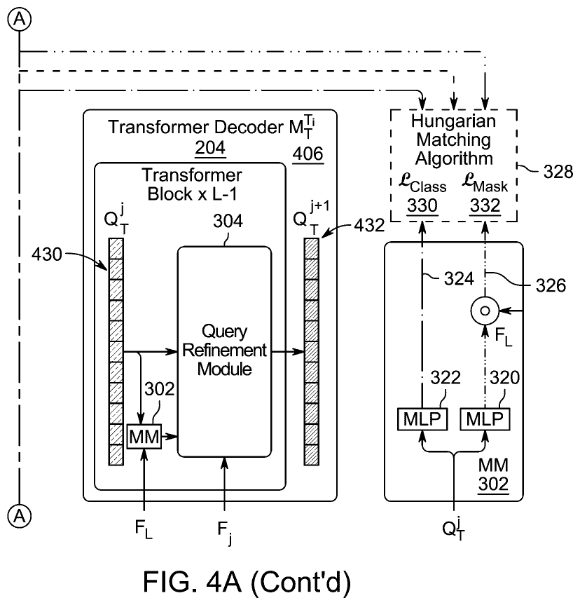

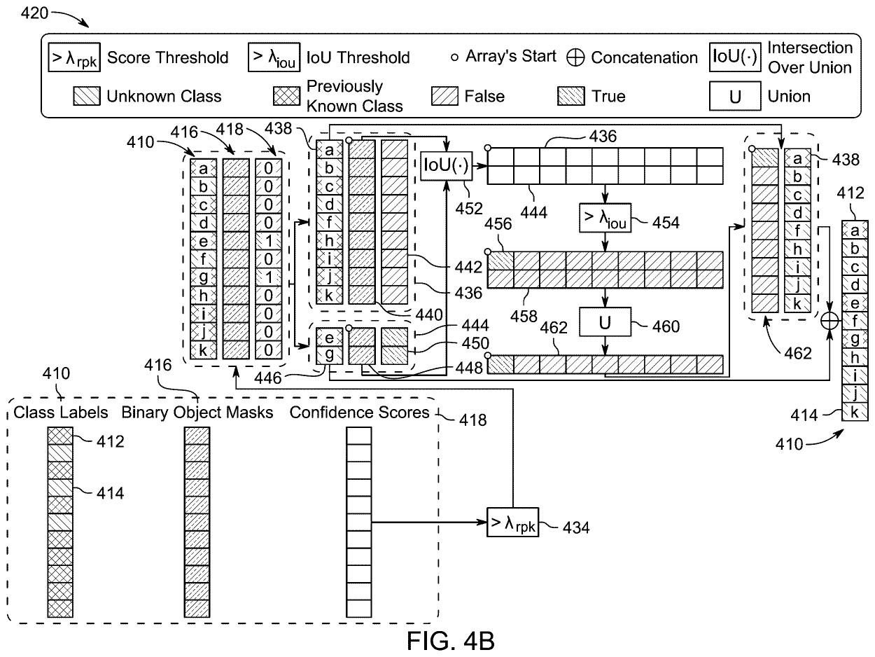

FIG. 4A illustrates a known-unknown self-distillation pipeline 400, according to certain embodiments. The pipeline 400 includes multiple interconnected stages, starting with an input 3D point cloud that is processed by a frozen teacher model

$${M}_{F}^{{T}_{i - 1}}$$

402 from a previous task, which generates a set of initial queries

$${Q}_{F}^{0}$$

404 and subsequently refined by the transformer decoder 204 to produce object binary masks and class labels for 3D instance segmentation. In an exemplary embodiment, the frozen teacher model

$${M}_{F}^{{T}_{i - 1}}$$

402 is a previously trained model that serves as a knowledge distillation source for a current task. The teacher model

$${M}_{F}^{{T}_{i - 1}}$$

402 remains frozen, meaning its weights are not updated during training. In general, a teacher model acts as a reference model, providing high-confidence pseudo-labels and assisting in knowledge retention to prevent the catastrophic forgetting in the open-world 3D instance segmentation. The teacher model extracts hierarchical voxel features using the sparse 3D convolutional network encoder 202. Since the teacher model was trained on the previous tasks, the teacher model contains learned knowledge about previously seen object categories, making it valuable for self-distillation representations by incorporating self-attention and masked cross-attention mechanisms with extracted feature maps.

In an embodiment, the frozen teacher model

$${M}_{F}^{{T}_{i - 1}}$$

402 refines a number of queries nor to generate n_{Q}_{_{F}} class labels and binary object masks in an input scene. In an exemplary embodiment, the transformer decoder 204 within the frozen teacher model

$${M}_{F}^{{T}_{i - 1}}$$

402 refines the set of initial queries

$${Q}_{F}^{0}$$

404 to generate a set of refined queries denoted as:

$${Q}_{F} = {Q}_{F}^{L} , \qquad ( 4 )$$

where Q_{F} represents final refined queries from the frozen teacher model

$${M}_{F}^{{T}_{i - 1}}$$

402, L represents a number of blocks of the transformer decoder 204 used for query refinement. The final refined queries are then used to generate the object binary masks and the class labels for the instance segmentation.

In an exemplary embodiment, the transformer decoder 204 takes the extracted voxel features and the set of initial queries

$${Q}_{F}^{0}$$

404 as input. Through the self-attention and the cross-attention mechanisms, the transformer decoder 204 refines the set of initial queries

$${Q}_{F}^{0}$$

404 by attending to different regions of the feature map. The transformer decoder 204 produces an output of a set of refined embeddings (i.e., a collection of enhanced feature vectors, where each refined embedding represents an individual object instance in the 3D point cloud. The transformer decoder 204 utilizes the refined embeddings to generate the object binary masks and the class labels, which define and categorize different segmented objects in the 3D scene. The object binary masks generated by the transformer decoder 204 are referred to as refined instance masks when further processed by the MM 302.

Following the transformer decoder 204, the MM 302 takes the refined instance masks and compares the refined instance masks with previously learned masks to generate pseudo-labels for instances that belong to previously known classes 412. The pseudo-labels act as supervision signals, guiding a current task model (i.e., student model)

$${M}_{T}^{{T}_{i}}$$

406 during training. The generated object binary masks and class labels are then passed to the SDM 206, where predictions of the object binary masks and the class labels are further refined and integrated into a current training cycle.

Further, the current task model (i.e., student model)

$${M}_{T}^{{T}_{i}}$$

406 represents an actively training model for a current task, designed to incorporate both new knowledge and retain previously learned information. The student model

$${M}_{T}^{{T}_{i}}$$

406 follows a structure similar to the frozen teacher model

$${M}_{F}^{{T}_{i - 1}}$$

402 but includes crucial learning mechanisms to update network parameters.

Initially, the input 3D point cloud is processed by the sparse 3D convolutional network encoder 202, which generates hierarchical feature maps that capture the spatial and semantic information. The feature maps are inputs to the transformer decoder 204 and the MM 302. Concurrently, a set of learnable queries

$${Q}_{T}^{0}$$

408, unique to the current task, are introduced to guide the transformer decoder 204 in identifying object instances within the point cloud.

The transformer decoder 204 takes the extracted features and the learnable queries

$${Q}_{T}^{0}$$

408, applying the self-attention and the cross-attention mechanisms to learn instance-aware embeddings. This enables the model to produce high-quality object segmentations and mask refinements. Unlike the frozen teacher model

$${M}_{F}^{{T}_{i - 1}}$$

402, the student model

$${M}_{T}^{{T}_{i}}$$

406 incorporates the MM 302 within the transformer decoder 204 itself. The MM 302 compares the predicted instance masks with previously learned masks and current task predictions, enforcing consistency across sequential tasks to mitigate the catastrophic forgetting and enhance model stability in the open-world 3D instance segmentation.

The MM 302 is directly linked to a loss function L that supervises model training. The loss function consists of a mask loss Lₘₐₛₖ 332 and a classification loss L_{class} 330, ensuring that the predicted instance masks align with the ground truth. The presence of the MM 302 at multiple stages enables intermediate supervision, reducing the likelihood of the catastrophic forgetting while ensuring a smooth integration of new knowledge.

The SDM 206 is designed to refine the pseudo-labels generated by the teacher model

$${M}_{F}^{{T}_{i - 1}}$$

402 and ensure effective separation between the previously known classes 412 and the unknown classes 414. The SDM 206 receives outputs from the MM 302 of the frozen teacher model

$${M}_{F}^{{T}_{i - 1}}$$

402: one output is an array of class labels 410, where the previously known classes model 412 are represented in a box of X-shaped pattern and the unknown classes 414 are represented in a box of a horizontal line pattern). The other output is an array of the object binary masks 416, represented in a box of a dotted striped pattern.

To improve pseudo-labeling, both the outputs are passed through an objectness function (O) 418 that evaluates their confidence scores. The objectness function (O) 418 is defined as:

O:(mϵR^{N},pϵ[0,1])→[0,1], (5)

where the objectness function (O) 418 maps the object binary mask prediction m=fₘₐₛₖ(q) and a class probability p=max(f_{class}(q)) to the objectness score, which is represented in an array 426. The objectness function (O) 418 acts as a filtering mechanism, ensuring that only high-confidence predictions are utilized in training the student model

$${M}_{T}^{{T}_{i}}$$

406. A prediction with a high confidence score is likely to be a valid instance, while the predictions with lower confidence scores may be discarded or reprocessed.

Further, an Unknown-Known Separation (UKS) component 420, receives the predictions (pseudo-labels) from the teacher model

$${M}_{F}^{{T}_{i - 1}}$$

402 and target masks 422 of the known classes in Task Tᵢ to generate better pseudo-labels for the previously known classes 412 and the unknown classes 414. In many open-world learning scenarios, the classes that were unknown in a past task Tᵢ₋₁ may now have a known class label in the current task Tᵢ. However, if not separated correctly, the model may misclassify the previously known classes 412 as the unknown classes 414 or vice versa. The UKS component 420 mitigates this by comparing previous task predictions (from the teacher model

$${M}_{F}^{{T}_{i - 1}}$$

402) with the target masks 422 from the current task Tᵢ, identifying truly unknown classes 414 versus the classes that belong to the previously known classes 412 and refining the pseudo-labels to improve the distinction between the previously known classes 412 and the unknown classes 414.

Once the UKS component 420 has refined the pseudo-labels by distinguishing between the previously known classes 412 and the unknown classes 414, the pseudo labels, along with the ground truth labels, form training targets for the student model (

$${M}_{T}^{{T}_{i}}$$

406). The training targets used to train the student model

$${M}_{T}^{{T}_{i}}$$

406 in the current task Tᵢ are formulated to integrate the pseudo-labels and the ground truth labels, ensuring effective learning in the open-world setting. The training targets are defined as:

[symbol]

=\tilde{M}, [symbol] ,\tilde{S}=({m},{y},{s}|═(m,y,s)ϵP⊕U⊕GT_{T}_{ᵢ}), (6)

where \tilde{M} represents a set of masks, \tilde{Y} represents a set of labels and \tilde{S} represents a set of objectness scores predicted by the teacher model

$${M}_{F}^{{T}_{i - 1}}$$

404. GT_{T}_{ᵢ} represents the ground truth labels for the currently known classes from the incremental Task Tᵢ. The training targets are derived from three primary sources, such as the pseudo-labels for the previously known classes 412, denoted as P, which are extracted from the teacher model

$${M}_{F}^{{T}_{i - 1}}$$

402 of the previous task Tᵢ₋₁, the pseudo-labels for the unknown classes 414, denoted as U, which were misclassified in the past but have now been correctly identified; and the ground truth label GT_{T}_{ᵢ} which ensure that the model learns from verified annotations of the currently known classes in the Task Tᵢ.

After separation, the outputs are fed back into the array of class labels 410 to refine the predictions of the class labels. The array of class labels 410 is then concatenated with target classes 424, ensuring that the refined predictions of the class labels align with the target classes 424 of the current task Tᵢ. Meanwhile, the array of objectness scores 426 is further validated using ground truth confidence scores 428 (i.e., the array of objectness scores 426 is concatenated with boxes containing “1”, which indicates binary confidence scores (either 1 or 0). A confidence score of 1 indicates that a pseudo-label is considered highly reliable and should be used for training, while the confidence score of 0 indicates a low confidence prediction that may be discarded.

Similarly, the array of object binary masks 416 may be concatenated with the target masks 422 to align the predicted instance masks with ground-truth segmentation labels, facilitating supervised learning and enhancing the self-distillation process.

Further, the concatenated outputs are provided as input to the Hungarian Matching algorithm 328 (explained above in detail in FIG. 3). The Hungarian Matching algorithm 328 is a widely used method in the 3D instance segmentation for aligning the predicted and the ground truth labels based on optimal assignment. The Hungarian Matching algorithm 328 ensures that the best possible mapping is established between the refined class labels, confidence-filtered instances (column with “1”) and finalized instance masks.

The MM 302 processes instant queries

$${Q}_{T}^{j}$$

to generate the class and mask predictions which are subsequently evaluated using the Hungarian matching algorithm 328 with associated loss functions. The MM 302 operates by taking in a query representation

$${Q}_{T}^{j}$$

and passing the query representation

$${Q}_{T}^{j}$$

through the MLPs 320, 322. One MLP 322 is responsible for predicting the class label, while the other MLP 320 predicts the corresponding binary object mask. These outputs form the class predictions [symbol] , and the mask predictions [symbol] extracted from the trainable student model

$${M}_{T}^{{T}_{i}}$$

406 as:

[symbol]

={y=f_{class}(q)|∀qϵQ_{T}} (7)

[symbol]

={m=fₘₐₛₖ(q)|∀qϵQ_{T}} (8)

To refine the predictions, the outputs from the MM 302 are further processed by a feature transformation denoted as F_{L}. This operation applies additional transformations to enhance feature representations of the masks before feeding them into the Hungarian matching algorithm 328. Specifically, the mask outputs undergo a dot product with F_{L}, which acts as a learnable weighting mechanism that helps adjust the contributions of different masks based on their feature importance. This step ensures that only the most relevant masks contribute effectively to a final matching process.

To ensure alignment between the predictions and the ground-truth instances, the Hungarian matching algorithm 328 is performed between the predicted sets ( [symbol] , [symbol] ) and pseudo-label targets ( [symbol] , [symbol] ) generated by the SDM 206. [symbol] represents target instance masks used to train a trainable student model

$${M}_{F}^{{T}_{i}}$$

and [symbol] represents target instance class labels used to train the trainable student model

$${M}_{F}^{{T}_{i}} .$$

This process determines two permutation metrices, Πₚ and Πₜ, which optimally pair the predictions with the pseudo-label targets ( [symbol] , [symbol] ). Πₚ represents a permutation vector to match the prediction to the target and Πₜ represents a permutation vector to match the target to the prediction. Also, t denotes target labels and p denotes predictions. After matching, refined triplets

$$( {\overline{Y}}_{t}^{{T}_{i}} , {\overline{Y}}_{p}^{{T}_{i + 1}} , {\overline{S}}_{t}^{{T}_{i}} )$$

may be obtained, represented as:

$${\overline{Y}}_{t}^{{T}_{i}} = \tilde{Y} [ {\prod }_{t} ] , \qquad ( 9 )$$

$${\overline{Y}}_{p}^{{T}_{i + 1}} = \tilde{{Y}_{T}} [ {\prod }_{p} ] , \qquad ( 10 )$$

$${\overline{S}}_{t}^{{T}_{i}} = \tilde{S} [ {\prod }_{t} ] , \qquad ( 11 )$$

where

$${\overline{Y}}_{t}^{{T}_{i}}$$

represents matched target class labels,

$${\overline{Y}}_{p}^{{T}_{i + 1}}$$

represents matched predicted class labels, and

$${\overline{S}}_{t}^{{T}_{i}}$$

represents matched target target scores. The refined triplets ensure that the predictions align with the pseudo-labels.

The matched predictions are then optimized using a weighted loss function to balance contributions of known and unknown class pseudo-labels. The objective loss function is defined as:

$$\{ \begin{matrix}{L}_{owce} = \frac{1}{η} {\sum }_{( {y}_{p} , {y}_{t} , {s}_{t} ) ϵ {\overline{Y}}_{p}^{{T}_{i + 1}} , {\overline{Y}}_{t}^{{T}_{i}} , {\overline{S}}_{t}^{{T}_{i}}} {W}_{I} ( {s}_{t} , {y}_{t} ) \cdot l ( {y}_{p} , {y}_{t} ) \\ {W}_{I} ( {s}_{t} , {y}_{t} ) = \{ \begin{matrix}1 - 0.5 {e}^{- α ( {s}_{t} - 0.5 )} , & {s}_{t} > 0.5 , {y}_{t} = 0 \\ {s}_{t} , & {s}_{t} > 0.5 , {y}_{t} \neq 0 \\ 0 , & otherwise\end{matrix} ,\end{matrix} \qquad ( 12 )$$

where L_{owce} represents an open-world cross-entropy loss, l(yₚ, yₜ) represents the cross-entropy loss between the predicted and target class labels, Wₗ(sₜ, yₜ) represents an instance weighting function that adjusts the contribution of each instance to the loss based on its predicted score sₜ and the ground-truth label yₜ. 0 is the label for the unknown class, α is set to 15 for all experiments, and η is a normalization factor defined as follows:

$$η = {\sum }_{( {y}_{t} , {s}_{t} ) ∈ {\overline{Y}}_{t}^{{T}_{i}} , {\overline{S}}_{t}^{{T}_{i}}} {W}_{I} ( {s}_{t} , {y}_{t} ) \qquad ( 13 )$$

This formulation incorporates a weight adjustment mechanism based on the score prior sₜ. Since the pseudo-labels for the unknown classes 414 are fewer compared to the known classes 412, this weight adjustment mechanism upscales their contribution to the loss function, improving the model's ability to distinguish between the previously known classes 412 and the unknown classes 414. By prioritizing the high-confidence pseudo-labels and properly balancing a class-wise loss, this approach enhances the generalization of the model in open-world learning.

Further, the transformer decoder 204 within the student model

$${M}_{T}^{{T}_{i}}$$

406, which plays a crucial role in refining the instance queries over multiple transformer layers. The process begins with an initial set of instance queries 430,

$${Q}_{T}^{j} .$$

Within the transformer decoder 204, multiple transformer layers, denoted as L−1 stacked blocks, process and refine the queries using the self-attention mechanisms. The query refinement module 304 plays a key role in enhancing the initial set of instance queries 430,

$${Q}_{T}^{j}$$

by incorporating contextual dependencies, ensuring that the mask instances are better segmented and classified. This iterative process results in an updated set of refined queries,

$${Q}_{T}^{j + 1} ,$$

432, which are subsequently passed to later stages of the pipeline 400 for further processing.

FIG. 4B illustrates a visual representation of the UKS component 420, according to certain embodiments. The UKS component 420 is configured to separate the predictions of the previously known classes 412 from the unknown classes 414 in the open-world 3D instance segmentation. The UKS component 420 is essential because, in the CIL, newly introduced known classes may have been misclassified as the unknown classes 414 in earlier tasks. The UKS component 420 refines the pseudo-labels to differentiate the previously known classes 412 and the unknown classes 414 correctly.

The UKS component 420 receives model predictions as input, which includes the class labels (i.e., predicted object categories) 410, the binary object masks 416 (i.e., object instance boundaries), and the confidence scores 418 (prediction reliability) for different object instances. The object instances are represented as a, b, c, . . . , k, where X-shaped patterns indicate the previously known classes 412, and the horizontal-line patterns 414 indicate the unknown classes 414. To filter out low-confidence predictions, a score threshold (λᵣₚₖ) 434 is applied. The predictions with the confidence score above the score threshold (λᵣₚₖ) 434 are retained for further processing, ensuring that unreliable predictions do not contribute to a pseudo-labeling process. Further, to address the challenge of separating the unknown classes 414 from the previously known classes 412, the high-confidence predictions that meet the score threshold (λᵣₚₖ) 434 are selected to form a Right Previously Known (RPK) set, as determined using equation (14) and (15). The RPK set consists of instances that are most likely to belong to the previously known classes 412. The remaining predictions, which do not meet the score threshold (λᵣₚₖ) 434 or were not assigned to the previously known classes 412, are collected into R̅P̅K̅ set defined using equation (16) and (17).

RPK={(1[m>0.5],argmax(pr),O(m,max(pr))|O(m,max(pr))>λᵣₚₖ, (14)

m=fₘₐₛₖ(q),pr=f_{class}(q),∀qϵQ_{F}} (15)

where m represents the predicted mask of the object instance, pr represents class probability scores predicted by the model for each object instance, argmax (pr) returns the class label with the highest probability from the predicted class scores (pr), O represents the objectness function 418 that maps the object binary mask and the class probability to the objectness score and Q_{F} represents the set of initial queries to be fed to the transformer decoder 204 of a frozen teacher model M^{Ti}_{F}. The equation (14) and (15) ensures that only the predictions with a high objectness score are classified as part of the previously known classes 412. The binary values (0 and 1) in the FIG. 4B corresponds to a filtering step such as 1 (True), which means that the prediction has met the score threshold (λᵣₚₖ) 434 and is considered part of the RPK set and 0 (False) means that the prediction does not meet the score threshold (λᵣₚₖ) 434 and will be processed further.

RPK={(1[m>0.5],argmax(pr),O(m,max(pr))|(1[m>0.5],argmax(pr)∉RPK, (16)

m=fₘₐₛₖ(q),pr=f_{class}(q),∀q∈Q_{F}} (17)

As shown in FIG. 4B, each predicted instance (a, b, c, d, . . . , k) has an associated segmented mask m, the predicted class probability pr, and the confidence score O(m, max(pr)). The confidence score O(m, max(pr)) is compared to the score threshold (λᵣₚₖ) 434. If O(m, max(pr))>λᵣₚₖ 434, the instance is assigned a binary value equal to 1 (indicating that it is highly confident and likely belongs to the previously known classes 412) and if O(m, max(pr))<=λᵣₚₖ 434, the instance is assigned the binary value to 0 (indicating that it is uncertain and may belong to the unknown classes 414). As shown in the FIG. 4B, the instances e and g have been assigned the binary value 1, meaning they passed a threshold check and are classified as the RPK set and all other instances are assigned 0, meaning they did not pass the score threshold (λᵣₚₖ) 434 and are placed in R̅P̅K̅ set.

After separating the RPK set (instances with binary 1) and the R̅P̅K̅ set (instances with binary 0), two different groups are created. In a first group 436, there is an array of object instances 438 represented as (a, b, c, d, f, h, i, j, k), an array of corresponding object binary masks 440 and an array of corresponding confidence scores 442. Similarly, in a second group 444, there is an array of object instances 446 represented as (e and g), an array of corresponding object binary masks 448 and an array of corresponding confidence scores 450. Both groups 436, 444 are passed through an Intersection over Union (IoU) 452. The IoU 452 refines the pseudo-labels by measuring the overlap between the predicted masks and known class masks (derived from the ground truth labels available for the currently known classes in the incremental task). In an exemplary embodiment, the predictions (predicted segmented mask) from the RPK set are compared with the target masks (not shown). The IoU 452 is computed for each prediction to determine how well it aligns with the target masks. If the predicted instance from the RPK set has low IoU 452 (i.e., an overlap lower than a predefined threshold (λᵢₒᵤ) 454, it is reassigned as an unknown pseudo-label (U) 460 as shown in equation (18). This reassignment is crucial for distinguishing truly new instances from misclassified known instances, preventing the model from mistakenly reinforcing incorrect classifications. Conversely, if the predicted instance from the RPK set maintains a high IoU 452 with previously known instances (it exceeds (λᵢₒᵤ) 454), it is retained as a previously known pseudo-label and contributes to a refined set P as shown in equation (19):

$$U = \{ ( {m}_{\overline{rpk}} , 0 , {s}_{\overline{rpk}} ) \vert IoU ( {m}_{rpk} , {m}_{\overline{rpk}} ) < {λ}_{iou} , \\ ( {m}_{rpk} , {c}_{rpk} , {s}_{rpk} ) ∈ RPK , \\ ( {m}_{\overline{rpk}} , {c}_{\overline{rpk}} , {s}_{\overline{rpk}} ) ∉ \overline{RPK \}} , \qquad ( 18 )$$

$$\tilde{P} = \{ ( {m}_{\overline{rpk}} , {c}_{\overline{rpk}} , {s}_{\overline{rpk}} ) \vert IoU ( {m}_{rpk} , {m}_{\overline{rpk}} ) > {λ}_{iou} , \\ ( {m}_{rpk} , {c}_{rpk} , {s}_{rpk} ) ∈ RPK , \\ ( {m}_{\overline{rpk}} , {c}_{\overline{rpk}} , {s}_{\overline{rpk}} ) ∈ \overline{RPK \}} ⊕ RPK \qquad ( 19 )$$

where mᵣₚₖ represents the segmentation mask of the instance that is part of the RPK set, cᵣₚₖ represents the predicted class label of the instance that belongs to the RPK set and sᵣₚₖ represents the confidence score of the instance within the RPK set, indicating how certain the model is about the prediction, m_{r̅p̅k̅} represents the segmentation mask of the instance not included in the RPK set, c_{r̅p̅k̅} represents the predicted class label of the instance not assigned to the RPK set, and s_{r̅pk} represents the confidence score of the instance not classified as the RPK set.

As shown in FIG. 4B, a first row 456 represents the evaluation of the previously known instances, where a true value indicates that the predicted instance from the RPK set has a high IoU 452 (>λᵢₒᵤ 454) with the previously known instance and is retained in the refined set of previously known pseudo-labels (\tilde{P}). Conversely, a false value signifies that the predicted instance has a low IoU 452 and is therefore not retained as the known pseudo-label (\tilde{P}). The second row 458 consists entirely of false values, indicating that none of the instances in this row 458 met the IoU threshold (λᵢₒᵤ) 454 and are not considered as the previously known pseudo-labels (\tilde{P}).

Following this, the instances that failed the IoU check are reassigned to the unknown pseudo-label set (U) 460. This is represented in a third row 462, where a true value in a first box signifies that the corresponding instance has been reclassified as the unknown pseudo-label (U) 460, while the remaining predictions remain false, indicating that they were not eligible for reclassification. This process ensures that only reliable known instances are retained, while the low-confidence predictions that do not sufficiently overlap with the known instances are treated as unknowns.

In a final stage, the refined pseudo-labels are used to improve training for a next incremental task. The final classification results, where the box of X-shaped structure represents the previously known classes 412, and the box of horizontal line pattern represents the unknown classes 414. This separation technique enhances the model's ability to learn new classes while maintaining knowledge of old ones, preventing errors from propagating through the incremental learning process. By leveraging IoU-based separation and confidence filtering, the model produces more accurate pseudo-labels, which contribute to better generalization on unknown instances and improved performance in the open-world 3D instance segmentation.

For example, a final output after concatenation represents a refined segmentation of the previously known classes 412 and the unknown classes 414, ensuring clear distinctions based on the confidence scores and the IoU filtering. The first column 462 consists of binary values, where the first box is marked as true (represented in a dotted pattern), indicating that a specific instance has been reassigned as the unknown pseudo-label (U) 460, while the remaining boxes are false (represented as stripped pattern), meaning they were not reassigned. This column 462 plays a crucial role in identifying which instances have been moved to the unknown pseudo-label set based on their low IoU 452 with the target masks.

The second column 438 contains the predicted class labels, but only for those instances that had a false value during the >(λᵣₚₖ) 434 filtering step. These predicted labels include (a, b, c, d, f, h, i, j, k) because they did not meet the high-confidence threshold required to be classified as the RPK set.

Finally, these two columns 462, 438 are concatenated into a single output representation, which provides a refined classification of all instances with accurate pseudo-label assignments. The final output 410 maintains a structured pattern distribution, where ‘a’ remains in the box of the X-shaped pattern as the previously known class 412, while ‘b, c, d’ are classified as the unknown classes 414 and appear in the box of the horizontal-line pattern. Additionally, ‘e’ and ‘g,” which were previously identified as the high-confidence predictions, retain their classification as the previously known classes 412 and appear in the box of the X-shaped pattern. The remaining instances ‘f, h, i, j, k’ are classified as the unknown classes 414 and are represented in the box of the horizontal-line pattern. By generating the pseudo-labels with high confidence and spatial validation, this process enhances the performance and accuracy of the open-world 3D instance segmentation.

Beyond the IoU-based filtering and the confidence thresholding used for refining the pseudo-labels, it is also essential to measure how semantically similar the unknown classes are to the previously known classes. This is achieved using a similarity estimation in a contrastive language image pre-training (CLIP) embedding space, where known class and unknown class embeddings are compared to quantify their relationships.

The similarity estimation between the unknown classes and the known classes is performed in the CLIP embedding space to analyze how closely the unknown classes resemble the previously known classes. This process begins by encoding names of all known classes in Task T₁ using a CLIP text encoder. Each class name is transformed into a textual input in a format: “This is a photo of {class name}”. The resulting text embeddings of the known classes are represented as K, such that KϵRⁿ^{_{K*}}^{D}, where D is the dimensionality of the CLIP embedding space, and n_{K} represents the total number of known classes. Similarly, unknown class names, along with class ‘others’, are encoded using the CLIP text encoder, producing embeddings denoted as UϵR⁽ⁿ^{_{U}}^{+1)*D}, where n_{U} represents the number of unknown classes.

To quantify the relationship between the known classes and the unknown classes, a similarity matrix is computed by applying a dot product between known and unknown embeddings represented in equation (20):

SϵRⁿ^{_{K*}}⁽ⁿ^{_{U}}⁺¹⁾, (20)

where S=Softmax (100*K·U^{T}) applied to a last dimension. This approach normalizes the similarity scores and ensures that they represent probability distributions. In an embodiment, the i-th row of S, denoted as Sᵢ, captures how similar the i-th known class is to all unknown classes.

To determine how strongly the known class is associated with its most similar unknown classes, a sum of Top-k probabilities in Sᵢ, excluding the class ‘others”, which measures the probability of the existence of at least one unknown class resembling the known class i in the Top-k unknown classes similar to i. For example, if the known class is ‘chair’ and the unknown classes include ‘armchair’, ‘folded chair’, and ‘refrigerator’, the similarity measurement may yield P₁=0.74, P₂=1.00, and P₃=1.00. Here, P₁=0.74 indicates that the most similar unknown class to ‘chair’ has a 74% similarity. Meanwhile, P₂=1.00 signifies that at least one of the top two unknown classes is entirely similar to ‘chair’, and P₃=1.00 confirms that within the top three unknown classes, at least one shares complete similarity with the known class.

The similarity estimation process plays a crucial role in refining the open-world segmentation system by helping distinguish whether the unknown class should be grouped closer to the known class or remain truly new. By leveraging the CLIP embeddings and probabilistic similarity analysis, the model can better understand relationships between previously seen and unseen classes, improving the overall accuracy of the segmentation pipeline.

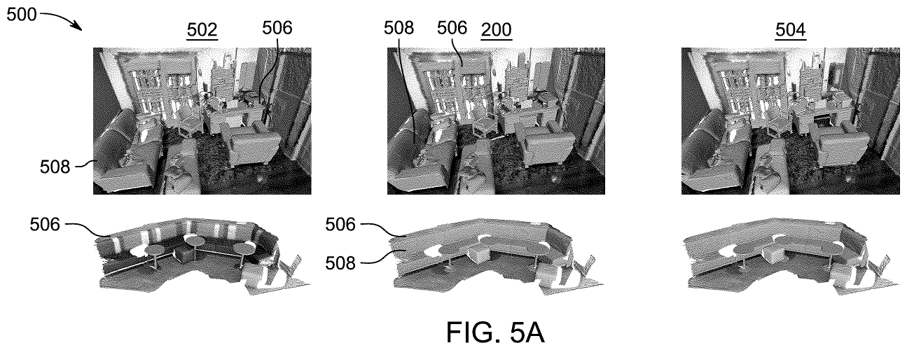

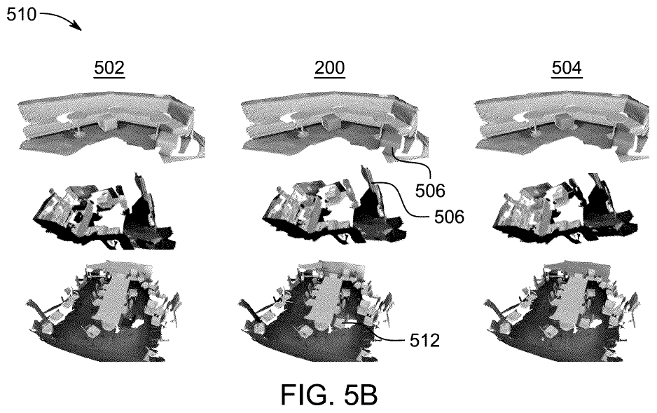

FIG. 5A illustrates a visualization of a first qualitative comparison 500 of segmentation results of a conventional system 502, the system 200, and a ground truth 504, according to certain embodiments. The comparison 500 is structured in two rows, each showcasing a 3D scene segmented by different models, allowing for a qualitative evaluation of their performance.

In the conventional system 502 using 3D-OWIS, results of a previous open-world 3D instance segmentation method are displayed. However, the conventional system 502 struggles with accurately segmenting the unknown classes 506, leading to misclassified classes and failure to detect certain unknown classes 506. In addition, generated segmentation masks tend to be inaccurate, either failing to capture the full extent of objects or mislabeling regions, thereby reducing overall segmentation reliability.

The system 200 integrates self-distillation and open-world loss optimization to refine the segmentation accuracy. The system 200 effectively identifies the unknown classes 506 which were previously overlooked or misclassified by a baseline model (3D-OWIS). The system 200 not only improves recognition of the unknown classes 506 but also ensures that previously learned knowledge of the known classes 508 is preserved, addressing shortcomings of prior methods. By leveraging the pseudo-labels and objectness priors, the system 200 achieves significant improvements in recognizing both known classes 508 and the unknown classes 506, making it a more robust solution for the open-world 3D segmentation.

Further, the ground truth 504 serves as a reference standard, showing actual segmentation labels for a scene. The ground truth 504 provides a benchmark against which a performance of different models is measured. By visually comparing the results, it is evident that the system 200 significantly outperforms the conventional system 502.

FIG. 5B illustrates a visualization of a second qualitative comparison 510 between the conventional system 502, the system 200, and the ground truth 504, according to certain embodiments. The comparison 510 illustrates improvements in the 3D instance segmentation. The visualizations depict three different scenes where OpenDistill3D used by the system 200 outperforms the 3D-OWIS used by the conventional system 502 in accurately segmenting both the previously known classes (not shown) and the unknown classes 506. In a first scene of the system 200, the OpenDistill3D generates fewer false positives from the unknown classes 506 compared to the 3D-OWIS, correctly classifying the stool chair (unknown) 506, whereas the 3D-OWIS fails to distinguish it properly. In a second scene of the system 200, the OpenDistill3D correctly segments background objects as the unknown classes 506, leading to more precise instance masks, while the 3D-OWIS misclassifies some of these regions, showing incorrect segmentations. In a third scene of system 200, the OpenDistill3D correctly segments a currently known class 512, such as a chair (at bottom-right), that the 3D-OWIS fails to classify properly, highlighting the effectiveness of the OpenDistill3D. These improvements are due to high-quality unknown class pseudo-labels used during the training, which enhance OpenDistill3D's ability to generalize to the new classes while preserving the segmentation accuracy for the known classes.

### Experimental Results

Tables 1A-1C represent a comparative analysis of SDM 206 against state-of-the-art approaches for open-world 3D instance segmentation on ScanNet200 dataset. The ScanNet200 dataset includes reconstructed point clouds of indoor scenes with labels for 200 object classes. Tables 1A-1C report performance across three open-world splits (Split A, Split B, and Split C), evaluating metrics such as a wilderness impact (WI), an absolute open-set error (A-OSE), an unknown recall (U-Recall), and a mean average precision (mAP) for both previously known classes and current classes.

TABLE 1A
Comparison between the approach of this
disclosure and 3D-OWIS; Task T₁

| Task Id | | | | |
|---|---|---|---|---|
| Task T₁ | | | | |
| | | | mAP (↑) | |
| | | | Current | |
| | | | known | All |
| WI (↓) | A-OSE (↓) | U-Recall (↑) | classes | classes |

Split A

| | | | | | |
|---|---|---|---|---|---|
| Upper Bound | 0.057 | 290 | 62.82 | 39.51 | 39.38 |
| Mask3D | | | | 39.12 | 39.12 |
| 3D-OWIS | 0.397 | 607 | 34.75 | 40.20 | 39.70 |
| SDM 206 | 0.841 | 564 | 41.27 | 39.29 | 38.81 |
| | | | +6.52 | | |

Split B

| | | | | | |
|---|---|---|---|---|---|
| Upper Bound | 1.000 | 791 | 72.08 | 29.00 | 29.19 |
| Mask3D | | | | 23.48 | 23.48 |
| 3D-OWIS | 3.684 | 1780 | 24.79 | 23.60 | 23.30 |
| SDM 206 | 0.873 | 1243 | 30.11 | 26.03 | 25.71 |
| | | | +5.32 | | |

Split C

| | | | | | |
|---|---|---|---|---|---|
| Upper Bound | 0.583 | 853 | 70.80 | 25.90 | 26.10 |
| Mask3D | | | | 20.82 | 21.15 |
| 3D-OWIS | 0.419 | 1294 | 14.34 | 18.00 | 17.60 |
| SDM 206 | 0.876 | 1403 | 29.31 | 25.22 | 24.90 |
| | | | +14.97 | | |

In Task T₁, the teacher model

$${M}_{F}^{{T}_{0}}$$

is initialized with a closed-set model trained for epochs on the known classes only.

For Split A, the SDM 206 achieves the U-Recall of 41.27% in Task T₁, significantly outperforming the 3D-OWIS (34.75%) and illustrating a +6.52% improvement. In Split B, the SDM 206 consistently outperforms the 3D-OWIS, achieving higher U-Recall (30.11%) in Task T₁ compared to 24.79% from the 3D-OWIS, with a +5.32% improvement. For Split C, the SDM 206 delivers a remarkable gain of +14.97% in the U-Recall (29.31% vs. 14.34% in the 3D-OWIS) and +5.3% improvement in the mAP, emphasizing its superior ability to recognize the unknown classes and accurately segment the known classes.

TABLE 1B
Comparison between the approach of
this disclosure and 3D-OWIS; Task T₂

| | Task T₂ | | | | | |
|---|---|---|---|---|---|---|
| | | | | mAP (1) | | |
| | | | | Previously | Current | |
| Task Id | WI | A-OSE | U-Recall | known | known | All |
| (→) | (↓) | (↓) | (↑) | classes | classes | classes |
| | Split A | | | | | |
| Upper | 0.000 | 60 | 42.51 | 39.02 | 20.91 | 31.53 |
| Bound | | | | | | |
| Mask3D | | | | 38.30 | 20.57 | 29.15 |
| 3D-OWIS | 0.007 | 126 | 27.03 | 29.40 | 16.40 | 22.70 |
| SDM 206 | 0.352 | 199 | 48.82 | 36.21 | 15.61 | 25.65 |
| | | | +21.79 | +6.81 | | |
| | Split B | | | | | |
| Upper | 0.400 | 400 | 73.16 | 24.60 | 23.86 | 24.48 |
| Bound | | | | | | |
| Mask3D | | | | 21.81 | 18.91 | 20.37 |
| 3D-OWIS | 0.755 | 581 | 24.21 | 18.70 | 17.30 | 17.90 |
| SDM 206 | 0.781 | 758 | 33.78 | 24.64 | 17.85 | 21.53 |
| | | | +9.57 | +5.94 | | |
| | Split C | | | | | |
| Upper | 0.500 | 469 | 71.61 | 25.20 | 26.45 | 25.91 |
| Bound | | | | | | |
| Mask3D | | | | 22.67 | 26.67 | 24.13 |
| 3D-OWIS | 0.152 | 303 | 15.80 | 13.90 | 22.20 | 17.80 |
| SDM 206 | 1.371 | 849 | 41.31 | 26.02 | 22.66 | 24.24 |
| | | | +25.51 | +12.12 | | |

In Task T₂, the SDM 206 extends its learning from Task T₂ by incorporating new classes while ensuring that previously learned knowledge is retained. Unlike Task T₁, where the teacher model

$$( {M}_{F}^{{T}_{0}} )$$

is initialized from the closed-set model, Task T₂ builds upon the trained teacher model

$$( {M}_{F}^{{T}_{0}} )$$

from Task T₁ to guide a learning process. This allows the model to incrementally adapt to new unknown classes while preventing catastrophic forgetting of the previously known classes.

For Split A, the SDM 206 achieves a significant improvement in the U-Recall, reaching 48.82%, which is +21.79% higher than the 3D-OWIS (27.03%). Additionally, the SDM 206 exhibits a higher mAP across the previously known classes and the current classes, confirming its ability to effectively balance adaptation and knowledge retention.

In Split B, the SDM 206 continues to outperform the 3D-OWIS, attaining 33.78% U-Recall, marking a +9.57% improvement over the 3D-OWIS (24.21%). The consistent boost in the mAP for both previously known classes and the current classes further illustrates its capacity to integrate new class information while preserving segmentation accuracy for older categories.

For Split C, the SDM 206 achieves 41.31% U-Recall, which is a +25.51% gain over the 3D-OWIS (15.80%). This illustrates the model's enhanced ability to identify the unknown classes while maintaining strong segmentation performance for the known classes.

TABLE 1C
Comparison between the approach of this
disclosure and 3D-OWIS; Task T₃

Task Id
Task T₃

mAP (↑)

| | | |
|---|---|---|
| Previously known | Current known | |
| classes | classes | All classes |

Split A

| | | | |
|---|---|---|---|
| Upper Bound | 29.31 | 17.69 | 25.88 |
| Mask3D | 28.61 | 18.33 | 25.58 |
| 3D-OWIS | 20.20 | 15.20 | 18.70 |
| SDM 206 | 22.84 | 14.91 | 20.50 |
| | +2.64 | | |

Split B

| | | | |
|---|---|---|---|
| Upper Bound | 25.44 | 29.19 | 26.83 |
| Mask3D | 24.20 | 29.22 | 26.06 |
| 3D-OWIS | 18.70 | 24.60 | 20.90 |
| SDM 206 | 19.89 | 26.00 | 22.16 |
| | +1.19 | | |

Split C

| | | | |
|---|---|---|---|
| Upper Bound | 28.01 | 27.37 | 27.80 |
| Mask3D | 25.41 | 25.21 | 25.35 |
| 3D-OWIS | 17.80 | 17.70 | 17.80 |
| SDM 206 | 23.14 | 20.49 | 22.28 |
| | +5.34 | | |

In Task T₃, the SDM 206 extends the knowledge acquired from Task T₂, where the teacher model

$$( {M}_{F}^{{T}_{0}} )$$

was refined to incorporate the new classes while retaining the previously learned information. In this stage, the teacher model

$$( {M}_{F}^{{T}_{0}} )$$

undergoes further self-distillation to enhance adaptation to new object categories while maintaining segmentation performance on earlier learned instances. This progressive learning strategy ensures that the model effectively recognizes the previously known classes, even as new classes are introduced, while mitigating the risk of catastrophic forgetting. The results in Table 1C demonstrate the effectiveness of the SDM 206, as the SDM 206 consistently outperforms the 3D-OWIS in terms of mAP, particularly in Split C, where a significant improvement of +5.34% is observed.

In Split A, the SDM 206 achieves the mAP of 22.84% for the previously known classes, surpassing the 3D-OWIS (20.20%) by +2.64%. Although the mAP for the current classes is slightly lower (14.91% vs. 15.20% in 3D-OWIS), the overall segmentation accuracy improves, reflecting better knowledge retention and adaptability.

For Split B, the SDM 206 attains the mAP of 19.89% for the previously known classes, exceeding the 3D-OWIS (18.70%) by +1.19%. Moreover, the mAP for all classes combined shows a noticeable improvement over the 3D-OWIS, demonstrating better overall segmentation performance in an open-world setting.

In Split C, the SDM 206 achieves a significant gain of +5.34% in the mAP, with scores of 23.14% for the previously known classes and 22.28% for the all classes, clearly outperforming the 3D-OWIS (17.80%). This result indicates that the SDM 206 effectively mitigates the catastrophic forgetting while maintaining the high segmentation accuracy across both known and newly introduced classes.

Table 2 represents per-class results on a Replica dataset, illustrating a generalization capability of OpenMask3D when integrated with a self-distillation method (OpenDistill3D). Table 2 illustrates object classes where at least one model reports zero mAP50, emphasizing challenges of generalizing to unseen geometries.

The self-distillation method (OpenDistill3D) is trained on ScanNet200 labels for the same number of epochs as the OpenMask3D, with the addition of pseudo-labels for the unknown classes generated by the SDM 206. The teacher model used in this setup is a pre-trained Mask3D on ScanNet200, allowing for knowledge transfer to the OpenMask3D. The results indicate that the OpenMask3D with the OpenDistill3D significantly improves the segmentation performance across multiple previously unrecognized classes. Notably, categories such as clock, tissue paper, tablet, basket, and blanket, which were assigned zero mAP by OpenMask3D (with Mask3D), now achieve 31.2%, 27.2%, 26.4%, 25.9%, and 7.5% mAP, respectively, when using the OpenMask3D (with OpenDistill3D).

These findings demonstrate the effectiveness of unknown-known self-distillation in enhancing the adaptability of open-vocabulary models to new geometries, ensuring better segmentation of previously unseen object classes. Table 2 further illustrates that the OpenDistill3D adapts well to the new classes with varying geometries in the Replica dataset, reinforcing its potential for improving the open-world 3D instance segmentation.

TABLE 2
Per class results on Replica dataset

| | | tissue- | | | | | | |
|---|---|---|---|---|---|---|---|---|
| class | lock | paper | tablet | basket | blanket | pillar | sculpture | Mean |
| OpenMask3D | 0.00 | 0.00 | 0.00 | 0.00 | 0.00 | 15.0 | 27.3 | 15.90 |
| (with/Mask3D) | | | | | | | | |
| OpenMask3D | 31.2 | 27.2 | 26.4 | 25.9 | 07.5 | 0.00 | 0.00 | 18.40 |
| (with/OpenDistill3D) | | | | | | | | |

Table 3 represents a generalizability performance of the OpenMask3D in an open-vocabulary setting when evaluated on the Replica dataset using three different proposal methods: Mask3D, 3D-OWIS, and OpenDistill3D. The results illustrate the impact of self-distillation-based learning in enhancing the segmentation performance on unseen datasets.

TABLE 3
Generalizability test results

| Training classes | Proposal Method | mAP (%)↑ | mAP₅₀ (%)↑ | mAP₂₅ (%)↑ |
|---|---|---|---|---|
| Scannet200 | Mask3D | 09.50 | 15.90 | 22.90 |
| | 3D-OWIS | 09.70 | 15.60 | 24.10 |
| | OpenDistill3D | 11.00 | 18.40 | 23.30 |

As shown in Table 3, the OpenDistill3D achieves the highest performance among the proposal methods, with mAP50 of 18.40%, surpassing both Mask3D (15.90%) and 3D-OWIS (15.60%). These improvements confirm that training with the pseudo-labels for the unknown classes, as introduced in the self-distillation method (OpenDistill3D), provides a stronger foundation for open-world generalization. By leveraging the OpenDistill3D for 3D mask proposal generation, the model significantly outperforms the closed-set training in Mask3D and Auto Labeling-based methods in the 3D-OWIS, reaffirming the effectiveness of an unknown-known self-distillation strategy.

Tables 4A-4B represent an ablation study conducted to analyze the impact of each component introduced in a self-distillation framework for the open-world 3D instance segmentation. Tables 4A-4B evaluate the effects of the UKS component 420 and a weight function (W_{I}) balancing across multiple tasks. The results are reported for Task T₁ and Task T₂ on Split C, using evaluation metrics such as WI, A-OSE, U-Recall, and mAP across different class groups.

TABLE 4A
Ablation results; Task T₁

| | Task ID (→) | | Task T₁ | | | | |
|---|---|---|---|---|---|---|---|
| Row | UKS | | | | | Current | |
| ID | component | | WI | A-OSE | U-Recall | known | All |
| (↓) | 420 | W_{I} | (↓) | (↓) | (↑) | classes | classes |
| 1 | X | X | 1.015 | 1391 | 29 | 23.12 | 22.83 |
| 2 | ✓ | X | 1.015 | 1391 | 29 | 23.12 | 22.83 |
| 3 | ✓ | ✓ | 0.876 | 1403 | 29.31 | 25.22 | 24.90 |

TABLE 4B
Ablation results; Task T₂

| | Task | | Task T₂ | | | | | |
|---|---|---|---|---|---|---|---|---|
| | ID (→) | | | | | mAP (↑) | | |
| | UKS | | | | | Pre- | Cur- | |
| Row | com- | | | A- | U- | viously | rent | |
| ID | ponent | | WI | OSE | Recall | known | known | All |
| (↓) | 420 | W_{I} | (↓) | (↓) | (↑) | classes | classes | classes |
| 1 | X | X | 1.853 | 778 | 36.57 | 22.47 | 21.46 | 21.83 |
| 2 | ✓ | X | 2.211 | 875 | 39.53 | 24.04 | 22.26 | 23.30 |
| 3 | ✓ | ✓ | 1.371 | 849 | 41.31 | 26.02 | 22.66 | 24.24 |

In Task T₁, since there are no previously known classes, the first two rows (with and without UKS component 420) share the same checkpoint. Row 1 represents a baseline model without UKS component 420 or W_{I}, achieving a U-Recall of 29% and mAP of 23.12% for current known classes. The involvement of the UKS component 420 in Row 2 improves performance in Task T₂, with an increase in the U-Recall from 36.57% to 39.53% and a notable mAP improvement (24.04% vs. 22.47%) for the previously known classes. This demonstrates that the UKS component 420 effectively separates the unknown classes from the previously known classes, leading to better pseudo-labeling quality.

In Row 3, the inclusion of W_{I}-based balancing further refines the performance, significantly improving the U-Recall to 41.31% in Task T₂ while reducing W_{I} (1.371 vs. 2.211 in Row 2). Additionally, the mAP for the previously known classes increases to 26.02%, and overall segmentation accuracy improves (24.2% vs. 23.30%), highlighting the ability of W_{I} to balance learning between the known classes and the unknown classes.

In an embodiment, a student model

$$( {M}_{T}^{{T}_{1}} )$$

is trained for 600 epochs using labels for the known classes and the pseudo-labels for the unknown classes generated by the SDM 206. In subsequent tasks, both teacher and student models are initialized from the best checkpoint of a previous task

$$( {M}_{T}^{{T}_{1}} ) .$$

The student model is then further trained for 400 epochs on the new classes, incorporating the pseudo-labels for the previously known classes and the unknown classes. This progressive learning strategy ensures continuous adaptation, as reflected in Row 3 of Tables 4A-4B, where the UKS component 420 and W_{I} contribute to superior performance.

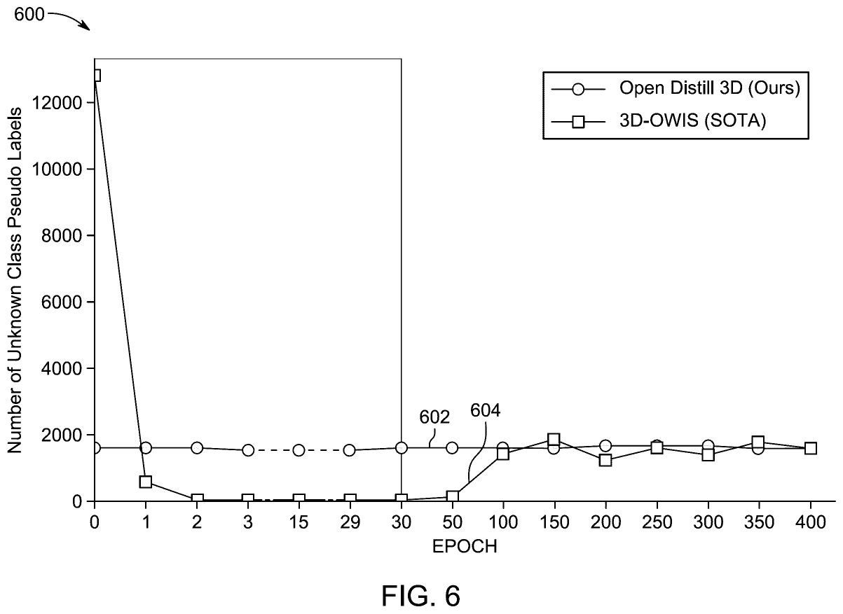

FIG. 6 illustrates a graphical representation 600 of the number of pseudo-labels generated for the unknown classes over training epochs, according to certain embodiments. FIG. 6 represents a comparison of OpenDistill3D 602 with a state-of-the-art (SOTA) 3D-OWIS 604. The x-axis denotes the number of training epochs, while the y-axis represents the number of pseudo-labels generated for the unknown classes. The results indicate a stark contrast between the two approaches in terms of consistency and retention of unknown class pseudo-labels throughout training.

In the 3D-OWIS 604, a sharp decline is observed in pseudo-label generation within first few epochs. This occurs because the 3D-OWIS 604 employs a two-stage pseudo-labeling approach, where the student model generates the pseudo-labels based on its own learned objectness cues. However, as the 3D-OWIS 604 undergoes training, it rapidly forgets previously known classes, as seen in a highlighted region. This catastrophic forgetting results in a significant reduction in the ability to generate new proposals for the unknown classes, leading to an overall decline in open-world segmentation performance.

Conversely, the OpenDistill3D 602 maintains a relatively stable and higher number of pseudo-labels for the unknown classes throughout training. This advantage arises from the self-distillation framework, where a frozen pre-trained teacher model guides the student model, ensuring better retention of the previously learned knowledge while generating high-quality and consistent pseudo-labels from early training epochs until the end.

The implications of these findings are reflected in Tables 1A-1C, where the SDM 206 significantly improves the performance of the student model on the unknown classes compared to the 3D-OWIS 604. However, since OpenDistill3D 602 generates a relatively higher number of pseudo-labels, this results in slight performance degradation in the WI and A-OSE, as observed in Tables 1A-1C.

Table 5 represents a similarity analysis between the known classes and the unknown classes in the CLIP embedding space.

TABLE 5
Similarity analysis results

| Top k unknowns | Split A | Split B | Split C |
|---|---|---|---|
| 1 | 36.63 | 22.68 | 35.24 |
| 2 | 54.69 | 31.51 | 43.94 |
| 3 | 64.06 | 45.21 | 50.00 |

Table 5 quantifies a percentage of the known classes that exhibit a high semantic similarity (above 0.9) with the unknown classes across different ScanNet200 splits (A, B, and C). The results indicate that a significant portion of the known classes have semantically similar unknown counterparts, which can lead to misclassification when using the closed-set model. For instance, in Split A, 36.63% of the known classes have at least one unknown class with a similarity score above 0.9, and this percentage increases as more top-k unknown classes are considered, reaching 64.06% at k=3. A concrete example illustrating this similarity is that the known class “chair” is highly similar to the unknown classes “armchair” and “folded chair”, leading to potential misclassifications in the closed-set setting. This example suggests that the closed-set models, such as Mask3D, may mislabel the unknown classes as known classes due to their resemblance, thereby reducing their segmentation performance. The results emphasize the need to handle the unknown classes explicitly to improve model generalization and reduce classification errors.

Table 6 represents a closed-set 3D instance segmentation performance of different models serving as class-agnostic mask proposal generators in the OpenMask3D. Table 6 compares various methods, including Mask3D and the self-distillation method, both with and without density-based spatial clustering of applications with noise (DBSCAN) clustering, based on the mAP at different IoU thresholds (mAP, mAP₅₀, and mAP₂₅).

TABLE 6
Closed-set 3D instance segmentation results

| | mAP (↑) | mAP₅₀ (↑) | mAP₂₅ (↑) |
|---|---|---|---|
| CSC | | 25.24 | |
| LGround | | 26.09 | |
| Mask3D (without | 25.73 | 34.09 | 38.87 |
| DBSCAN) | | | |
| Self-distillation | 27.37 | 35.98 | 41.44 |
| method (without | | | |
| DBSCAN) | | | |
| Mask3D (with | 27.40 | 37.00 | 42.30 |
| DBSCAN) | | | |
| Self-distillation | 28.00 | 37.20 | 43.40 |
| method (with | | | |
| DBSCAN) | | | |

The results demonstrate that the self-distillation method consistently outperforms the Mask3D in both settings. Without the DBSCAN, the self-distillation method achieves the mAP of 27.37%, surpassing Mask3D's 25.73%, and with the DBSCAN, the self-distillation method further improves to 28.00%, outperforming the Mask3D at 27.40%. Also, as shown in Table 1A, the Upper Bound model, trained on the unknown classes in the closed-set setting, surpasses the Mask3D, which is trained only on the currently known classes, particularly in Task T₁ on the currently known classes. These findings validate the effectiveness of explicit supervision on the unknown classes through the self-distillation method, which improves Mask3D's performance on the 200 classes of a ScanNet200 validation set.

Table 7 presents the impact of different weight functions W_{I} on WI, A-OSE, U-Recall, and mAP across three splits (A, B, and C) in Task T₁.

TABLE 7
Choice of score rescaling function

| | Task ID | | | | |
|---|---|---|---|---|---|
| | Task T₁ | | | | |
| | | | | mAP (↑) | |
| | | | | Current | |
| Weight | | | | known | All |
| Function | WI (↓) | A-OSE (↓) | U-Recall (↑) | classes | classes |

Split A

| | | | | | |
|---|---|---|---|---|---|
| None | 0.543 | 559 | 43.47 | 38.11 | 37.66 |
| s | 0.719 | 480 | 40.83 | 39.59 | 39.09 |
| W_{I} (s) | 0.841 | 564 | 41.27 | 39.29 | 38.81 |

Split B

| | | | | | |
|---|---|---|---|---|---|
| None | 0.619 | 1179 | 30.35 | 24.68 | 24.39 |
| s | 0.347 | 1104 | 31.24 | 23.13 | 22.86 |
| W_{I} (s) | 0.873 | 1243 | 30.11 | 26.03 | 25.71 |

Split C

| | | | | | |
|---|---|---|---|---|---|
| None | 1.015 | 1391 | 29.00 | 23.12 | 22.83 |
| s | 0.838 | 1356 | 28.19 | 22.36 | 22.08 |
| W_{I} (s) | 0.876 | 1403 | 29.31 | 25.22 | 24.90 |

Table 7 illustrates the importance of rescaling the objectness scores for weighting the pseudo-labels. A first row (None) represents a case where no weighting function is used, leading to suboptimal performance. A second row(s) uses the objectness scores as weights, which improves the performance in Split A but reduces the performance in Splits B and C. A third row (weight function W_{I}(s)), which scales the objectness scores, achieves the best balance across all splits, enhancing the mAP for both known classes and unknown classes.

As observed in Table 7, the use of the weight function W_{I} significantly improves the performance of both known classes and the unknown class by balancing good and bad pseudo-labels. Also, in Table 7 (row 2 vs. row 1), it is observed that the self-distillation with W_{I} enhances learning efficiency, preventing a negative impact of the bad pseudo-labels on model training. Furthermore, the Unknown-Known separation in Table 7 also contributes to improved student model performance, ensuring that the model can better distinguish between two class categories. This observation aligns with the findings in Table 7, where the weight function W_{I}(s) significantly enhances the performance across all splits compared to both naive self-distillation and direct score weighting.

Table 8 represents the impact of using the exemplar replay and the SDM 206 for training the Mask3D model in the open-world 3D instance segmentation. The exemplar replay includes storing a small set of representative samples from previous tasks and replaying the representative samples during the training to prevent catastrophic forgetting. On the other hand, the SDM 206 transfers the knowledge from the frozen teacher model (trained in previous tasks) to the student model by generating the pseudo-labels, allowing the model to learn from both known and unknown classes without relying on the stored exemplars. Table 8 evaluates different training strategies based on metrics such as WI, A-OSE, U-Recall, and mAP for the previously known classes, the currently known classes, and all classes as shown below.

TABLE 8
Effect of using exemplar replay with self-distillation

| | | | | mAP (↑) | | |
|---|---|---|---|---|---|---|
| | | | | Previously | Currently | |
| | WI | A-OSE | U-Recall | known | known | All |
| | (↓) | (↓) | (↑) | classes | classes | classes |
| Exemplar | 0.007 | 126 | 27.03 | 29.40 | 16.40 | 22.70 |
| Replay (40 | | | | | | |
| exemplars | | | | | | |
| as in 3D- | | | | | | |
| OWIS) | | | | | | |
| SDM 206 | 0.352 | 199 | 48.82 | 36.21 | 15.61 | 25.65 |
| (used in | | | | | | |
| system | | | | | | |
| 200) | | | | | | |
| SDM 206 | 0.106 | 64 | 46.45 | 36.00 | 17.11 | 26.27 |
| and | | | | | | |
| Exemplar | | | | | | |
| replay (40 | | | | | | |
| exemplars) | | | | | | |

The results indicate that using only the exemplar replay (3D-OWIS method) helps retain past knowledge, achieving low W_{I} (0.007) and A-OSE (126), but struggles with the U-Recall (27.03%). In contrast, using the SDM 206 alone (without exemplars) significantly improves the U-Recall (48.82%), illustrating its effectiveness in detecting the unknown classes. However, the SDM 206 increases the A-OSE (199) and the WI (0.352), which introduces more incorrect predictions. Finally, combining the self-distillation with the exemplar replay balances both aspects, reducing the A-OSE (64) and the WI (0.106) while maintaining a high U-Recall (46.45%) and improving an overall mAP (26.27%). This illustrates that integrating the exemplar replay with the SDM 206 enhances both knowledge retention and unknown-class learning, leading to a more robust open-world segmentation model.

Table 9 represents a performance evaluation of the model under extreme data sparsity using a subset of the ScanNet200 dataset. Table 9 illustrates the effect of reducing a number of input points on different training strategies, comparing the SDM 206 against auto-labeling and the exemplar replay. The performance is measured using various key metrics, including WI, A-OSE, U-Recall, and mAP for the previously known classes, the currently known classes, and all classes.

TABLE 9
Performance comparison with sparse data

| | | | | | mAP (↑) | | |
|---|---|---|---|---|---|---|---|
| | | | | | Pre | Cur- | |
| Per- | | | A- | U- | viously | rently | |
| centage | | WI | OSE | Recall | known | known | All |
| sampled | | (↓) | (↓) | (↑) | classes | classes | classes |
| 25% | 3D- | 0.0 | 2 | 7.61 | 14.55 | 12.12 | 13.23 |
| | OWIS | | | | | | |
| | SDM | 0.294 | 108 | 39.89 | 28.42 | 11.50 | 19.75 |
| | 206 | | | | | | |
| 50% | 3D- | 0.0 | 14 | 6.82 | 18.93 | 15.09 | 16.86 |
| | OWIS | | | | | | |
| | SDM | 0.402 | 217 | 43.83 | 33.71 | 15.89 | 24.57 |
| | 206 | | | | | | |

The results demonstrate that the extreme data sparsity negatively impacts overall model performance. However, the SDM 206 significantly outperforms auto-labeling in recognizing the unknown classes while also mitigating the catastrophic forgetting better than the exemplar replay. When only 25% of the data points are sampled, the 3D-OWIS achieves the U-Recall of 7.61%, whereas the SDM 206 reaches 39.89%, indicating a substantial improvement in identifying the unknown classes. A similar trend is observed when 50% of the data points are used, where the U-Recall for the SDM 206 is 43.83%, compared to 6.82% for the 3D-OWIS. The SDM 206 also maintains a competitive mAP (24.57%), highlighting its robustness despite data sparsity.

A main reason for the superior performance of the SDM 206 is the use of the frozen teacher model, which provides high-quality pseudo-labels throughout the training, even when data is highly sparse. In contrast, auto-labeling relies on an actively trained model for pseudo-label generation, which suffers from degradation due to insufficient input points, leading to low-quality pseudo-labels and poor recognition of unknowns.

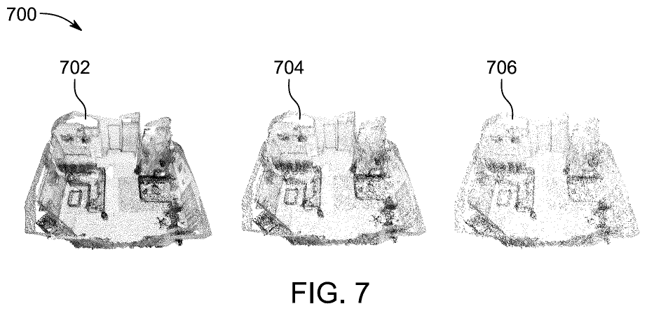

FIG. 7 illustrates qualitative results 700 of an input scene after progressively sampling different percentages (p %) of the input points, according to certain embodiments. The qualitative results 700 demonstrate the impact of point cloud sparsity on scene representation. As shown, a first image 702 represents a full input scene with 100% of the input points, capturing fine-grained structural details and object boundaries. Further, a second image 704, corresponding to 50% of the input points, retains the overall spatial layout but begins to lose finer details, particularly in smaller objects and textures. A third image 706, with only 25% of the input points, exhibits significant sparsity, leading to reduced clarity and loss of structural details. This visualization illustrates the effect of the point cloud density on 3D scene understanding, emphasizing challenges posed by reduced input data in open-world 3D segmentation tasks.

Table 10 represents a statistical analysis of the pseudo-labels generated by the SDM 206 in Task T₁. Table 10 provides insights into the quality and distribution of the pseudo-labels assigned to the unknown classes. Table 10 reports key metrics, including a total count of generated unknown pseudo-labels, a count of true unknown labels, Unknown Pseudo-labels to True-labels Ratio (UPTR), and statistical properties (i.e., mean and standard deviation (std)) of pseudo-label confidence scores.

TABLE 10
Statistics on the generated unknow class pseudo-labels in Task T₁

| | Unknown | Unknown | | | |
|---|---|---|---|---|---|
| | pseudo labels | truth labels | | Pseudo-labels | Pseudo-labels |
| Split | count | count | UPTR (%) | scores mean | scores std |
| A | 3591 | 5403 | 66.46 | 0.7587 | 0.1466 |
| B | 4253 | 14300 | 29.74 | 0.7648 | 0.1524 |
| C | 4501 | 16144 | 27.88 | 0.7648 | 0.1515 |

The UPTR is a crucial metric used to assess the reliability of the teacher model in generating the high-confidence pseudo-labels, which is defined using equation (21):

$$UTPR = \frac{Count of pseudo labels}{Count of true labels} \qquad ( 21 )$$

A higher UPTR indicates a larger proportion of generated pseudo-labels compared to the true labels, which may indicate over-generation, while a lower UPTR indicates a more conservative pseudo-labeling approach.

For each data split (A, B, and C), Table 10 reports the pseudo-label count, the true unknown label count, and the UPTR percentage. For instance, in Split A, the model generated 3591 unknown pseudo-labels compared to 5403 true unknown labels, resulting in the UPTR of 66.46%. This indicates that approximately 66.46% of the true unknown labels were matched by the pseudo-labels, indicating the effectiveness of the model in generating the pseudo-labels. Similarly, Split B exhibits a UPTR of 29.74% with 4253 pseudo-labels and 14300 true unknown labels, while Split C has a UPTR of 27.88%, showing a slight decline in pseudo-label generation accuracy.

Additionally, Table 10 reports the mean and standard deviation of the confidence scores for the generated pseudo-labels. The mean confidence scores across all splits remain relatively high, with values ranging between 0.7587 and 0.7648, indicating that most pseudo-labels are assigned with high certainty by the SDM 206. The standard deviation values range from 0.1466 to 0.1524, reflecting the variability in the confidence scores.

Overall, these statistics help evaluate the effectiveness of the SDM 206 in generating the pseudo-labels for the unknown classes. A higher mean confidence score indicates that the pseudo-labels are assigned with greater certainty, while the UPTR metric provides insights into how well the pseudo-labels align with the actual unknown classes.

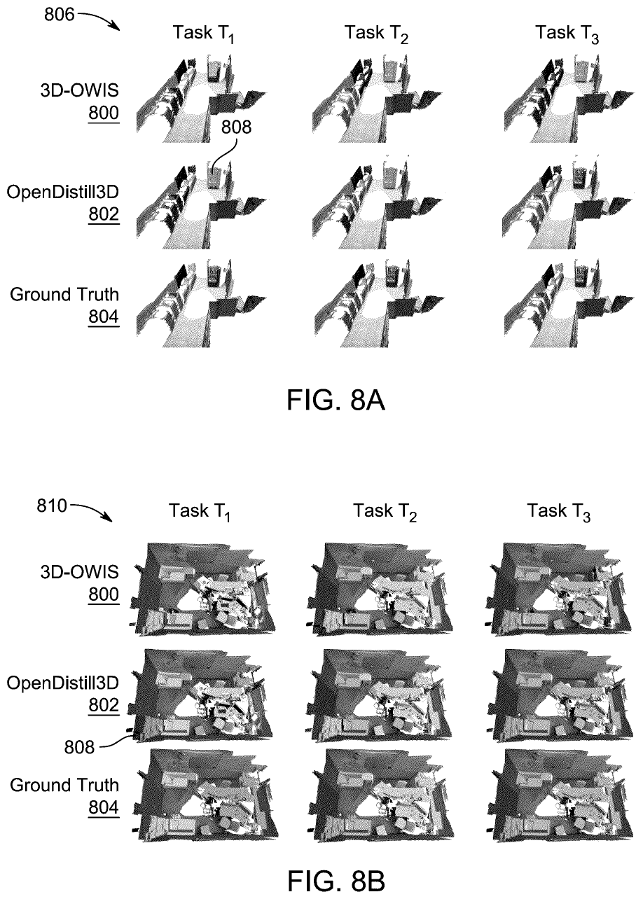

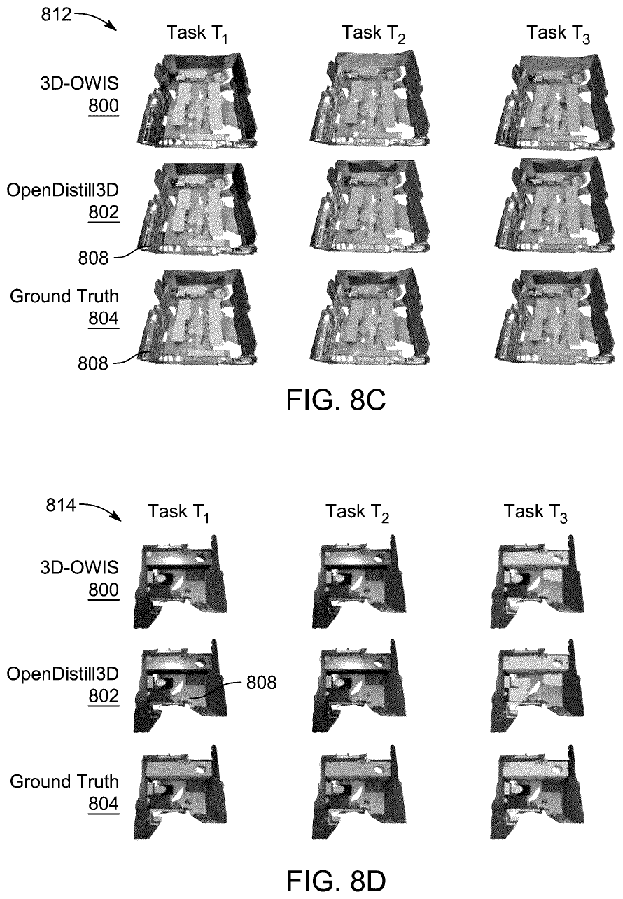

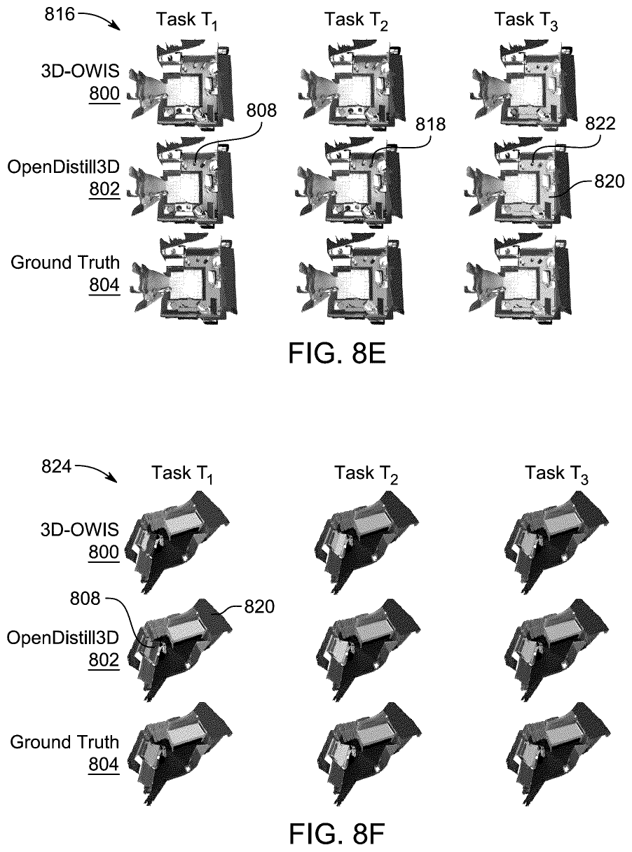

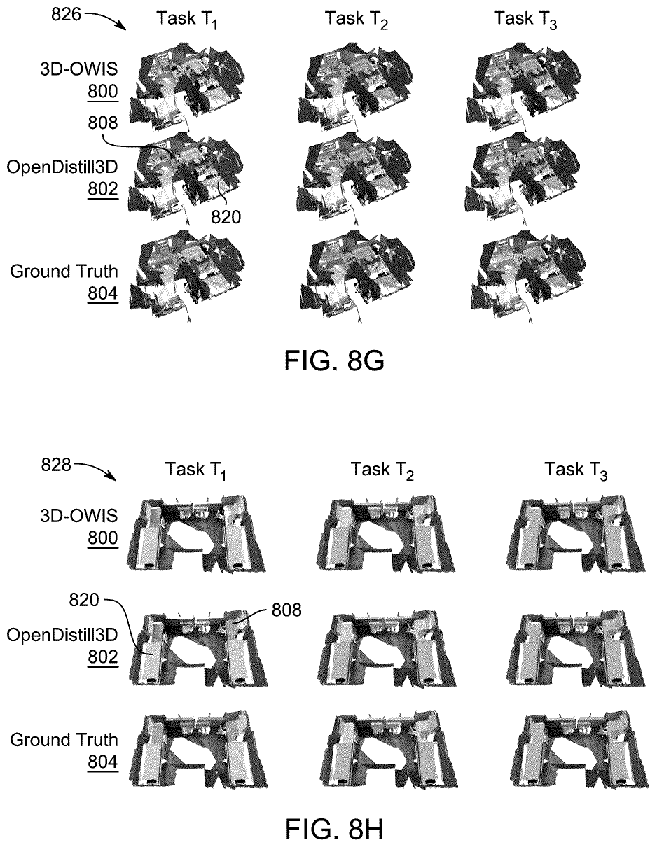

FIGS. 8A-8H illustrate an exemplary qualitative comparison between a 3D-OWIS 800, an OpenDistill3D (self-distillation) 802, and a ground truth 804 across three sequential tasks, according to certain embodiments. The qualitative comparison demonstrates the effectiveness of the OpenDistill3D 802 in an open-world 3D instance segmentation. In Task T₁, the OpenDistill3D 802 effectively captures unknown instances while correctly segmenting known instances. As the OpenDistill3D 802 progresses to Task T₂ and T₃, it continues to integrate newly learned instances while preserving prior knowledge, leading to a more structured and accurate segmentation compared to the 3D-OWIS 800. The OpenDistill3D 802 leverages self-distillation on the unknown instances, improving generalization and adaptation across the tasks while maintaining consistency with the ground truth 804.

In an exemplary embodiment, FIG. 8A represents a hallway scene 806 where the OpenDistill3D 802 correctly identifies a vending machine as an unknown class 808 in Task T₁, aligning with the ground truth 804. Unlike the 3D-OWIS 800, which struggles with unknown-known class separation, the OpenDistill3D 802 maintains accurate segmentation while integrating newly learned classes in Task T₂ and T₃. This indicates a superior adaptability of the OpenDistill3D 802 in the open-world 3D instance segmentation.

Further, in another exemplary embodiment, FIG. 8B illustrates a cluttered indoor setting 810 with numerous objects scattered across a room. The OpenDistill3D 802 successfully identifies cupboards placed on a corner of the room as the unknown class 808 in Task T₁, while preserving an integrity of known classes. With continuous learning in Task T₂ and T₃, the model refines its understanding, incorporating new class knowledge while maintaining structured segmentation. Compared to the 3D-OWIS 800, the OpenDistill3D 802 minimizes misclassification of previously known classes.

In yet another exemplary embodiment, FIG. 8C illustrates a classroom or a meeting room setting 812, with multiple chairs, tables and bookshelves arranged systematically. The ground truth 804 represents the unknown classes 808 such as chairs, benches, bookshelves or additional desk components. In Task T₁, the OpenDistill3D 802 correctly detects the unknown classes 808 while maintaining the segmentation for the previously known classes. As training progresses in Task T₂ and T₃, the OpenDistill3D 802 continuously integrates newly learned classes into its segmentation without forgetting previously learned knowledge. Compared to the 3D-OWIS 800, OpenDistill3D 802 achieves more structured segmentation with better adaptability to open-world settings.

In another exemplary embodiment, FIG. 8D represents a compact bathroom setup 814, with multiple objects, such as a toothbrush holder, sink-mounted objects, and certain floor items. The OpenDistill3D 802 correctly segments the unknown classes 808 (floor items) in Task T₁ while maintaining the segmentation for the previously known classes. As training progresses in Task T₂ and T₃, the OpenDistill3D 802 successfully integrates newly learned classes while retaining past knowledge. Compared to the 3D-OWIS 800, the OpenDistill3D 802 displays superior performance in distinguishing the unknown classes 808 and preserving segmentation accuracy.

In yet another exemplary embodiment, FIG. 8E illustrates a kitchen environment 816. In Task T₁, the OpenDistill3D 802 identifies various unknown classes 808, including kitchen utensils, small appliances, or objects placed on countertops and shelves, whereas the 3D-OWIS 800 struggles with proper segmentation. In Task T₂, previously unknown classes from T₁ are now learned, and new unknown classes 818 appear, such as additional kitchen items on surfaces, which the OpenDistill3D 802 correctly segments. By Task T₃, most classes have been classified into known categories (currently known classes 820 and previously learned classes 822), demonstrating the ability of the OpenDistill3D 802 to incrementally learn while retaining past knowledge.

In another exemplary embodiment, FIG. 8F illustrates a scene that appears to depict an indoor layout 824, possibly a bedroom or a dormitory setup, where different classes are progressively identified and learned. The unknown classes 808 likely represent tables or drawers within the room, while the currently known classes 820 correspond to structures such as beds, gates, and changing rooms. In Task T₁, the OpenDistill3D 802 recognizes previously unseen objects as unknown 808, similar to the ground truth 804, whereas the 3D-OWIS 800 exhibits inconsistencies. As learning progresses through Task T₂ and Task T₃, the OpenDistill3D 802 successfully integrates new knowledge, accurately segmenting the previously unknown objects while maintaining past knowledge.

In another exemplary embodiment, FIG. 8G illustrates a scene appears to depict a multi-room indoor layout 826, possibly resembling a residential or dormitory setting, where different classes are progressively identified and learned. The unknown classes 808 likely represent tables, storage units, or other furniture while the currently known classes 820 correspond to structures such as beds, seating areas, partitions and so forth. In Task T₁, the OpenDistill3D 802 recognizes previously unseen objects as the unknown 808, closely aligning with the ground truth 804, whereas the 3D-OWIS 800 exhibits inconsistencies. As learning progresses through Task T₂ and Task T₃, the OpenDistill3D 802 successfully integrates the new knowledge, accurately segmenting the previously unknown objects while preserving the past knowledge.

In another exemplary embodiment, FIG. 8H illustrates a scene appears to depict a structured indoor environment 828, possibly resembling a modular workspace or a symmetrical office layout. Different classes are progressively identified and segmented as learning advances. The unknown classes 808 likely correspond to small furniture pieces such as tables or storage units, while the currently known classes 820 may represent structural elements such as partitions, desks, or counters. In Task T₁, the OpenDistill3D 802 successfully identifies previously unseen objects as the unknown 808, aligning closely with the ground truth 804, whereas the 3D-OWIS 800 exhibits inconsistencies in segmentation. As learning progresses through Task T₂ and Task T₃, the OpenDistill3D 802 successfully integrates the new knowledge, accurately segmenting previously unknown objects while preserving the past knowledge.

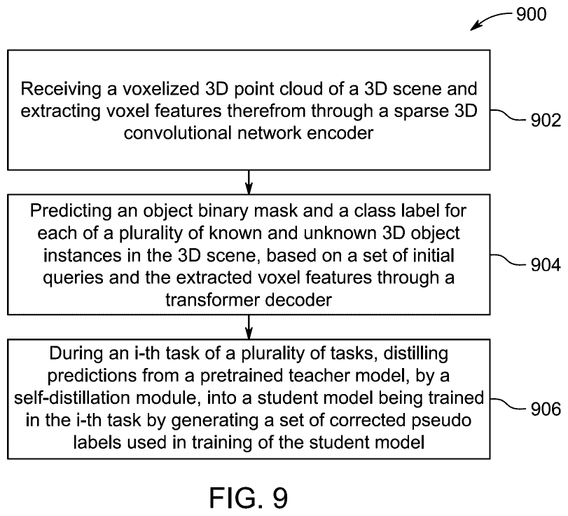

FIG. 9 illustrates a flowchart of an open-world 3D instance segmentation method 900 for generating masks and class labels for instances in a 3D scene, according to certain embodiments. The method 900 includes a series of steps. These steps are only illustrative, and other alternatives may be considered where one or more steps are added, one or more steps are removed, or one or more steps are provided in a different sequence without departing from the scope of the present disclosure.

At step 902, the method 900 includes receiving a voxelized 3D point cloud of the 3D scene and extracting voxel features therefrom through a sparse 3D convolutional network encoder 202. In an embodiment, the sparse 3D convolutional network encoder 202 includes a 3D U-Net-based convolutional neural network.

At step 904, the method 900 includes predicting an object binary mask and a class label for each of a plurality of known and unknown 3D object instances in the 3D scene, based on a set of initial queries and the extracted voxel features. This step includes predicting the object binary mask and the class label for each of the plurality of known and unknown 3D object instances via a transformer decoder 204. This step further includes refining, by the transformer decoder 204, the set of initial queries through a plurality of self-attention 316 and cross-attention 318 with the extracted voxel features to generate a set of refined queries. Each refined query is used to generate the object binary mask and the corresponding class label. In an embodiment, the transformer decoder 204 is trained over a plurality of tasks using class-incremental learning.

At step 906, the method 900 includes during an i-th task of the plurality of tasks, distilling the predictions from a pretrained teacher model, by SDM 206, into a student model being trained in the i-th task by generating a set of corrected pseudo labels used in training of the student model. In an embodiment, i is an integer greater than or equal to 1. In an embodiment, upon completion of an (i−1)-th task of the plurality of tasks, the student model is frozen and used as the teacher model for the i-th task to retain knowledge from previous tasks. For the i-th task with i=1, the teacher model is initialized with a closed-setting model pre-trained on known classes. In an embodiment, the teacher model and the student model have an identical architecture. Step 906 further includes correcting, by the SDM 206, predictions from the teacher model that belong to unknown classes but were misclassified as previously known classes. This step further includes concatenating, by the SDM 206, the set of corrected pseudo labels with ground-truth labels of known classes in the i-th task to generate a set of target pseudo labels for supervising the training of the student model.

Step 906 further includes estimating, by the SDM 206, an objectness score for each target pseudo label when generating the set of target pseudo labels. The objectness score is estimated based on an objectness function 418 that maps a mask prediction and a class probability to an objectness score ranging from 0 to 1.

The first embodiment is illustrated with respect to FIG. 2A-FIG. 3. The first embodiment discloses the open-world three-dimensional (3D) instance segmentation system 200 for generating masks and class labels for instances in a 3D scene is disclosed. The system 200 includes a sparse 3D convolutional network encoder 202. The system 200 further includes a transformer decoder 204. The system 200 further includes a self-distillation module 206. The sparse 3D convolutional network encoder 202 is configured to receive a voxelized 3D point cloud of the 3D scene and extract voxel features therefrom. The transformer decoder 204 is configured to predict an object binary mask and a class label for each of a plurality of known and unknown 3D object instances in the 3D scene, based on a set of initial queries and the extracted voxel features. The transformer decoder 204 is trained over a plurality of tasks using class-incremental learning. During an i-th task of the plurality of tasks, the self-distillation module 206 distills predictions from a pretrained teacher model into a student model being trained in the i-th task by generating a set of corrected pseudo labels used in training of the student model, where i is an integer greater than or equal to 1. Further, no exemplar replay is used during the training of the student model.

In an aspect, the teacher model and the student model have an identical architecture.

In an aspect, upon completion of an (i−1)-th task of the plurality of tasks, the student model is frozen and used as the teacher model for the i-th task.

In an aspect, for the i-th task with i=1, the teacher model is initialized with a closed-setting model pretrained on known classes.

In an aspect, when generating the set of corrected pseudo labels, the self-distillation module 206 corrects predictions from the teacher model that belong to unknown classes but were misclassified as previously known classes.

In an aspect, the self-distillation module 206 concatenates the set of corrected pseudo labels with ground-truth labels of known classes in the i-th task to generate a set of target pseudo labels for supervising the training of the student model.

In an aspect, when generating the set of target pseudo labels, the self-distillation module 206 estimates an objectness score for each target pseudo label.

In an aspect, the objectness score is estimated based on an objectness function 418 that maps a mask prediction and a class probability to an objectness score ranging from 0 to 1.

In an aspect, the transformer decoder 204 is further configured to refine the set of initial queries through a plurality of self-attention 316 and cross-attention 318 with the extracted voxel features to generate a set of refined queries, each refined query being used to generate an object binary mask and a corresponding class label.

In an aspect, the sparse 3D convolutional network encoder 202 includes a 3D U-Net-based convolutional neural network.

The second embodiment is illustrated with respect to FIG. 9. The second embodiment discloses the open-world three-dimensional (3D) instance segmentation method 900 for generating masks and class labels for instances in a 3D scene is disclosed. The method 900 includes via a sparse 3D convolutional network encoder 202, receiving a voxelized 3D point cloud of the 3D scene and extracting voxel features therefrom. The method 900 further includes via a transformer decoder 204, predicting an object binary mask and a class label for each of a plurality of known and unknown 3D object instances in the 3D scene, based on a set of initial queries and the extracted voxel features. The transformer decoder 204 is trained over a plurality of tasks using class-incremental learning. The method 900 further includes during an i-th task of the plurality of tasks, predictions from a pretrained teacher model are distilled by a self-distillation module 206 into a student model being trained in the i-th task by generating a set of corrected pseudo labels used in training of the student model, where i is an integer greater than or equal to 1. The method 900 further includes no exemplar replay is used during the training of the student model.

In an aspect, the teacher model and the student model have an identical architecture.

In an aspect, upon completion of an (i−1)-th task of the plurality of tasks, the student model is frozen and used as the teacher model for the i-th task.

In an aspect, for the i-th task with i=1, the teacher model is initialized with a closed-setting model pretrained on known classes.

In an aspect, when generating the set of corrected pseudo labels, the self-distillation module 206 corrects predictions from the teacher model that belong to unknown classes but were misclassified as previously known classes.

In an aspect, the self-distillation module 206 concatenates the set of corrected pseudo labels with ground-truth labels of known classes in the i-th task to generate a set of target pseudo labels for supervising the training of the student model.

In an aspect, when generating the set of target pseudo labels, the self-distillation module 206 estimates an objectness score for each target pseudo label.

In an aspect, the objectness score is estimated based on an objectness function 418 that maps a mask prediction and a class probability to an objectness score ranging from 0 to 1.

In an aspect, the transformer decoder 204 is further configured to refine the set of initial queries through a plurality of self-attention 316 and cross-attention 318 with the extracted voxel features to generate a set of refined queries, each refined query being used to generate an object binary mask and a corresponding class label.

In an aspect, the sparse 3D convolutional network encoder 202 includes a 3D U-Net-based convolutional neural network.

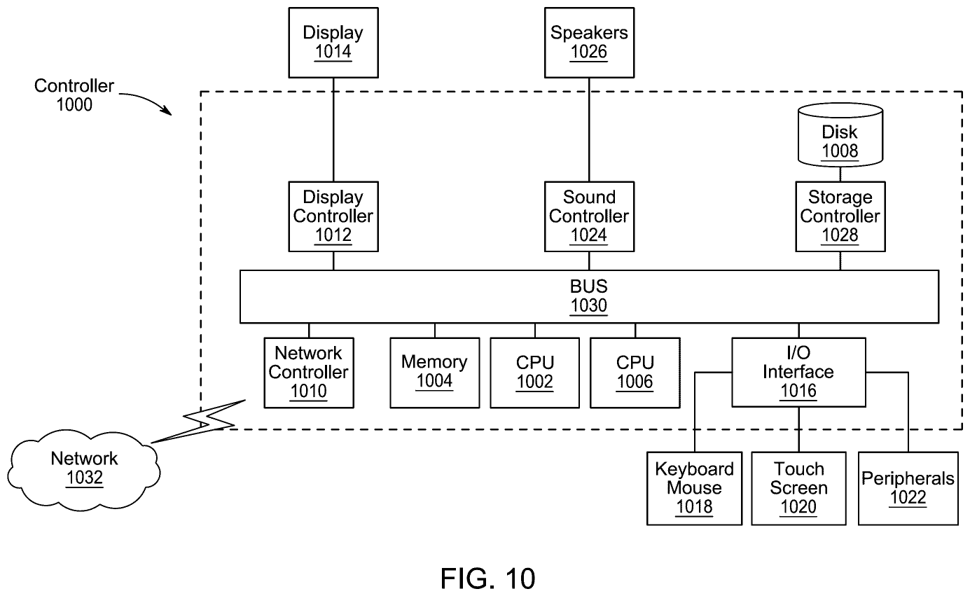

Next, further details of the hardware description of the computing environment according to exemplary embodiments are described with reference to FIG. 10. In FIG. 10, a controller 1000 is described as representative of the system 200 of FIG. 2A in which the controller 1000 includes a CPU 1002 which performs the processes described above/below. The process data and instructions may be stored in memory 1004. These processes and instructions may also be stored on a storage medium disk 1008 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 1002, 1006 and an operating system such as Microsoft Windows 7, Microsoft Windows 10, Microsoft Windows 11, UNIX, Solaris, LINUX, Apple MAC-OS and other systems known to those skilled in the art.

The hardware elements in order to achieve the computing device may be realized by various circuitry elements, known to those skilled in the art. For example, CPU 1002 or CPU 1006 may be a Xenon or Core processor from Intel of America or an Opteron processor from AMD of America, or may be other processor types that would be recognized by one of ordinary skill in the art. Alternatively, the CPU 1002, 1006 may be implemented on an FPGA, ASIC, PLD or using discrete logic circuits, as one of ordinary skill in the art would recognize. Further, CPU 1002, 1006 may be implemented as multiple processors cooperatively working in parallel to perform the instructions of the inventive processes described above.

The computing device in FIG. 10 also includes a network controller 1010, such as an Intel Ethernet PRO network interface card from Intel Corporation of America, for interfacing with network 1032. As can be appreciated, the network 1032 can be a public network, such as the Internet, or a private network such as an LAN or WAN network, or any combination thereof and can also include PSTN or ISDN sub-networks. The network 1032 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 1012, such as a NVIDIA GeForce GTX or Quadro graphics adaptor from NVIDIA Corporation of America for interfacing with display 1014, such as a Hewlett Packard HPL2445w LCD monitor. A general purpose I/O interface 1016 interfaces with a keyboard and/or mouse 1018 as well as a touch screen panel 1020 on or separate from display 1014. General purpose I/O interface also connects to a variety of peripherals 1022 including printers and scanners, such as an OfficeJet or DeskJet from Hewlett Packard.

A sound controller 1024 is also provided in the computing device such as Sound Blaster X-Fi Titanium from Creative, to interface with speakers/microphone 1026 thereby providing sounds and/or music.

The general purpose storage controller 1028 connects the storage medium disk 1008 with communication bus 1030, which may be an ISA, EISA, VESA, PCI, or similar, for interconnecting all of the components of the computing device. A description of the general features and functionality of the display 1014, keyboard and/or mouse 1018, as well as the display controller 1012, storage controller 1028, network controller 1010, sound controller 1024, and general purpose I/O interface 1016 is omitted herein for brevity as these features are known.

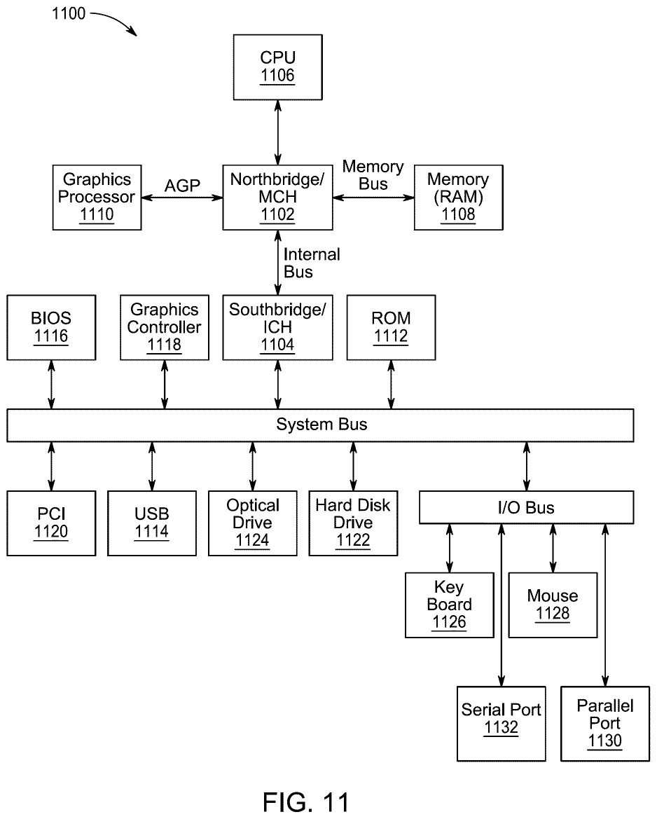

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 11.

FIG. 11 shows a schematic diagram of a data processing system 1100, according to certain embodiments, for performing the functions of the exemplary embodiments. The data processing system is an example of a computer in which code or instructions implementing the processes of the illustrative embodiments may be located.

In FIG. 11, data processing system 1100 employs a hub architecture including a north bridge and memory controller hub (NB/MCH) 1102 and a south bridge and input/output (I/O) controller hub (SB/ICH) 1104. The central processing unit (CPU) 1106 is connected to NB/MCH 1102. The NB/MCH 1102 also connects to the memory 1108 via a memory bus, and connects to the graphics processor 1110 via an accelerated graphics port (AGP). The NB/MCH 1102 also connects to the SB/ICH 1104 via an internal bus (e.g., a unified media interface or a direct media interface). The CPU Processing unit 1106 may contain one or more processors and even may be implemented using one or more heterogeneous processor systems.

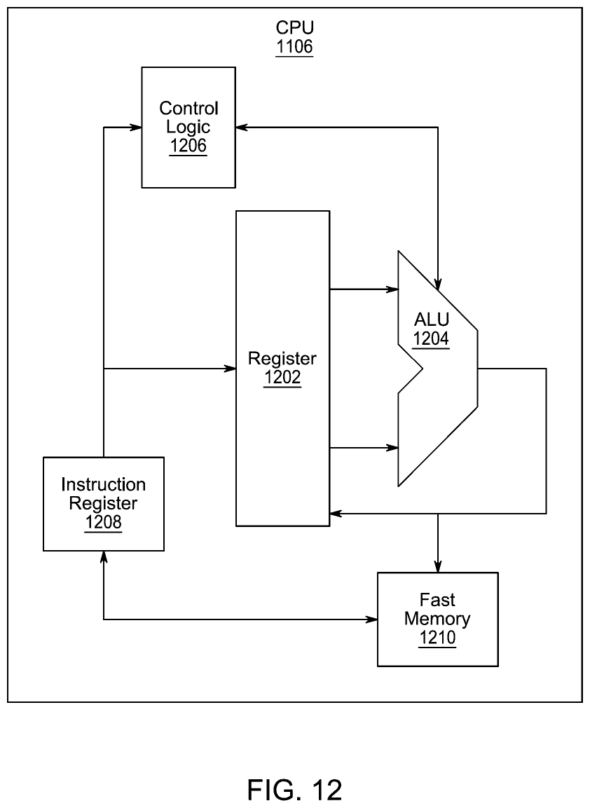

For example, FIG. 12 shows one implementation of CPU 1106. In one implementation, the instruction register 1208 retrieves instructions from the fast memory 1210. At least part of these instructions is fetched from the instruction register 1208 by the control logic 1206 and interpreted according to the instruction set architecture of the CPU 1106. Part of the instructions can also be directed to the register 1202. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using the arithmetic logic unit (ALU) 1204 that loads values from the register 1202 and performs logical and mathematical operations on the loaded values according to the instructions. The results from these operations can be feedback into the register and/or stored in the fast memory 1210. According to certain implementations, the instruction set architecture of the CPU 1106 can use a reduced instruction set architecture, a complex instruction set architecture, a vector processor architecture, a very large instruction word architecture. Furthermore, the CPU 1106 can be based on the Von Neuman model or the Harvard model. The CPU 1106 can be a digital signal processor, an FPGA, an ASIC, a PLA, a PLD, or a CPLD. Further, the CPU 1106 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 11, the data processing system 1100 can include that the SB/ICH 1104 is coupled through a system bus to an I/O Bus, a read only memory (ROM) 1112, universal serial bus (USB) port 1114, a flash binary input/output system (BIOS) 1116, and a graphics controller 1118. PCI/PCIe devices can also be coupled to SB/ICH 1104 through a PCI bus 1120.

The PCI devices may include, for example, Ethernet adapters, add-in cards, and PC cards for notebook computers. The Hard disk drive 1122 and optical drive 1124 can use, for example, an integrated drive electronics (IDE) or serial advanced technology attachment (SATA) interface. In one implementation the I/O bus can include a super I/O (SIO) device.

Further, the hard disk drive (HDD) 1122 and optical drive 1124 can also be coupled to the SB/ICH 1104 through a system bus. In one implementation, a keyboard 1126, a mouse 1128, a parallel port 1130, and a serial port 1132 can be connected to the system bus through the I/O bus. Other peripherals and devices that can be connected to the SB/ICH 1104 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

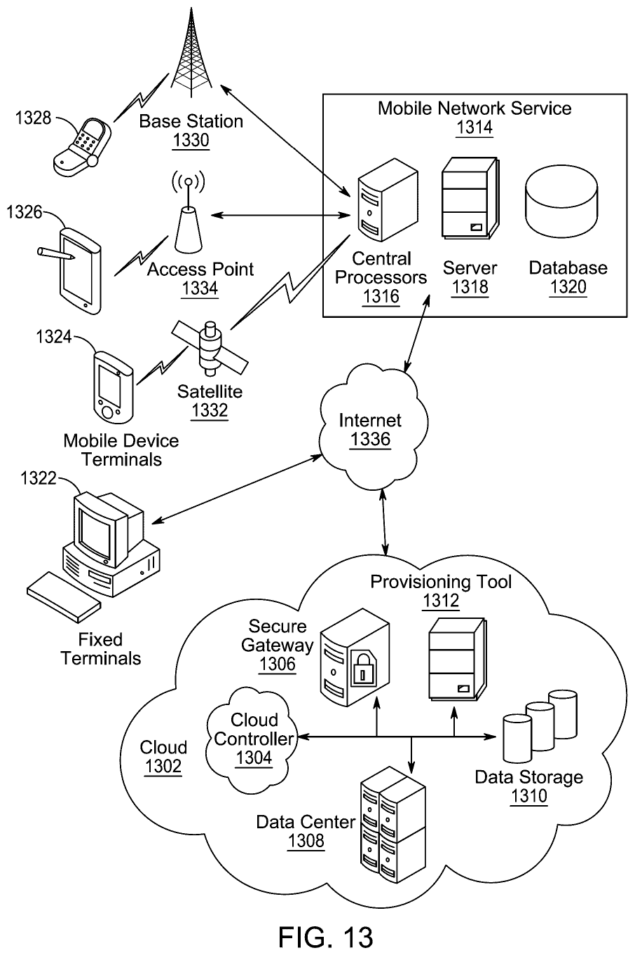

The functions and features described herein may also be executed by various distributed components of a system. For example, one or more processors may execute these system functions, wherein the processors are distributed across multiple components communicating in a network. The distributed components may include one or more client and server machines, such as cloud 1302 including a cloud controller 1304, a secure gateway 1306, a data center 1308, data storage 1310 and a provisioning tool 1312, and mobile network services 1314 including central processors 1316, a server 1318 and a database 1320, which may share processing, as shown by FIG. 13, in addition to various human interface and communication devices (e.g., display monitors 1322, smart phones 1328, tablets 1326, personal digital assistants (PDAs) 1324). The network may be a private network, such as a LAN, satellite 1332 or WAN 1334, or be a public network 1330, may such as the Internet 1336. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. An open-world three-dimensional (3D) instance segmentation system for generating masks and class labels for instances in a 3D scene, comprising:
a sparse 3D convolutional network encoder;
a transformer decoder; and
a self-distillation module, wherein
the sparse 3D convolutional network encoder is configured to receive a voxelized 3D point cloud of the 3D scene and extract voxel features therefrom,
the transformer decoder is configured to predict an object binary mask and a class label for each of a plurality of known and unknown 3D object instances in the 3D scene, based on a set of initial queries and the extracted voxel features,
the transformer decoder is trained over a plurality of tasks using class-incremental learning,
during an i-th task of the plurality of tasks, the self-distillation module distills predictions from a pretrained teacher model into a student model being trained in the i-th task by generating a set of corrected pseudo labels used in training of the student model, where i is an integer greater than or equal to 1, and
no exemplar replay is used during the training of the student model.

2. The system of claim 1, wherein the teacher model and the student model have an identical architecture.

3. The system of claim 2, wherein, upon completion of an (i−1)-th task of the plurality of tasks, the student model is frozen and used as the teacher model for the i-th task.

4. The system of claim 3, wherein for the i-th task with i=1, the teacher model is initialized with a closed-setting model pretrained on known classes.

5. The system of claim 1, wherein when generating the set of corrected pseudo labels, the self-distillation module corrects predictions from the teacher model that belong to unknown classes but were misclassified as previously known classes.

6. The system of claim 3, wherein the self-distillation module concatenates the set of corrected pseudo labels with ground-truth labels of known classes in the i-th task to generate a set of target pseudo labels for supervising the training of the student model.

7. The system of claim 6, wherein when generating the set of target pseudo labels, the self-distillation module estimates an objectness score for each target pseudo label.

8. The system of claim 7, wherein the objectness score is estimated based on an objectness function that maps a mask prediction and a class probability to an objectness score ranging from 0 to 1.

9. The system of claim 1, wherein the transformer decoder is further configured to refine the set of initial queries through a plurality of self-attention and cross-attention with the extracted voxel features to generate a set of refined queries, each refined query being used to generate an object binary mask and a corresponding class label.

10. The system of claim 1, wherein the sparse 3D convolutional network encoder includes a 3D U-Net-based convolutional neural network.

11. An open-world three-dimensional (3D) instance segmentation method for generating masks and class labels for instances in a 3D scene, comprising:
via a sparse 3D convolutional network encoder, receiving a voxelized 3D point cloud of the 3D scene and extracting voxel features therefrom; and
via a transformer decoder, predicting an object binary mask and a class label for each of a plurality of known and unknown 3D object instances in the 3D scene, based on a set of initial queries and the extracted voxel features, wherein
the transformer decoder is trained over a plurality of tasks using class-incremental learning, and
during an i-th task of the plurality of tasks, predictions from a pretrained teacher model are distilled by a self-distillation module into a student model being trained in the i-th task by generating a set of corrected pseudo labels used in training of the student model, where i is an integer greater than or equal to 1, and
no exemplar replay is used during the training of the student model.

12. The method of claim 11, wherein the teacher model and the student model have an identical architecture.

13. The method of claim 12, wherein, upon completion of an (i−1)-th task of the plurality of tasks, the student model is frozen and used as the teacher model for the i-th task.

14. The method of claim 13, wherein for the i-th task with i=1, the teacher model is initialized with a closed-setting model pretrained on known classes.

15. The method of claim 11, wherein when generating the set of corrected pseudo labels, the self-distillation module corrects predictions from the teacher model that belong to unknown classes but were misclassified as previously known classes.

16. The method of claim 13, wherein the self-distillation module concatenates the set of corrected pseudo labels with ground-truth labels of known classes in the i-th task to generate a set of target pseudo labels for supervising the training of the student model.

17. The method of claim 16, wherein when generating the set of target pseudo labels, the self-distillation module estimates an objectness score for each target pseudo label.

18. The method of claim 17, wherein the objectness score is estimated based on an objectness function that maps a mask prediction and a class probability to an objectness score ranging from 0 to 1.

19. The method of claim 11, wherein the transformer decoder is further configured to refine the set of initial queries through a plurality of self-attention and cross-attention with the extracted voxel features to generate a set of refined queries, each refined query being used to generate an object binary mask and a corresponding class label.

20. The method of claim 11, wherein the sparse 3D convolutional network encoder includes a 3D U-Net-based convolutional neural network.
